(19) United States
(12) Patent Application Publication
(10) Pub. No.: US 2015/0165871 A1
(43) Pub. Date: Jun. 18, 2015

(54) VEHICLE HEATING APPARATUS AND SYSTEM AND METHOD OF DOING THE SAME

(71) Applicant: Aqua-Hot Heating Systems, Inc., Frederick, CO (US)

(72) Inventors: Gerard Miller, Loveland, CO (US); Timothy Morse, Fort Collins, CO (US)

(21) Appl. No.: 14/569,151

(22) Filed: Dec. 12, 2014

Related U.S. Application Data
(60) Provisional application No. 61/915,929, filed on Dec. 13, 2013.

(51) Int. Cl. B60H 1/02

(52) U.S. Cl. CPC B60H 1/02

(57) ABSTRACT

An auxiliary or supplemental vehicle heating system that operates on natural gas or propane is provided for use with a vehicle engine having a liquid cooling/heating circuit. A propane- or natural gas-fired burner supplies heat during the operation or non-operation of the engine and the heat produced is used to supply heat to the engine, passenger compartment(s), mobile work areas, cargo containers and in the case of natural gas vehicles, provide heat to the on-board fuel system regulator. Thus, the auxiliary or supplemental heating system supplies heat independent of the engine's liquid cooling/heating circuit. In some embodiments, the cooling/heating circuit uses the heat produced from the natural gas or propane auxiliary heating system to supply heat to the engine via a heat exchanger.

### CROSS REFERENCE TO RELATED APPLICATIONS

This application claims priority from U.S. Provisional Patent Application Ser. No. 61/915,929, filed Dec. 13, 2013, entitled “Vehicle Heating Apparatus and System and Method of Doing the Same,” the entire disclosure of which is hereby expressly incorporated by reference herein in its entirety.

### FIELD OF THE INVENTION

Embodiments of the present invention generally relate to a device, system, and method for providing thermal energy to a motor vehicle. More specifically, embodiments of the invention relate to a supplemental heating device and system for natural gas- or propane-operated vehicles.

### BACKGROUND OF THE INVENTION

Some common cooling systems for motor vehicle combustion engines may also provide heat to occupant compartments of the vehicles. Existing systems often comprise a radiator, a fan that may be engine-driven, and a pump, that may be engine-driven, which circulates engine coolant from the engine to the radiator and back to the engine. Coolant heated by the running vehicle engine transfers heat to the radiator core through which the fan draws air to aid heat transfer from the core to the air. Thus, the air takes heat from the coolant to keep the engine cool. The warm air may then be used to heat occupant compartments of the vehicle.

Certain motor vehicles, such as trucks, for example, have occupant compartments (cabs) that include at least a driver's compartment and sometimes a sleeper compartment behind the driver's compartment. One way to provide cold weather heating for an occupant compartment is by allowing the engine to idle while the vehicle is parked to keep the engine coolant sufficiently hot for adequate heating by an occupant compartment heater through which the coolant is circulated. This, however, is wasteful of fuel because it necessitates running the engine.

An on-board auxiliary coolant heater can instead provide ample heating without running the engine (i.e., “no-idle” heating). One brand of commercially available heaters offers heaters with heat output ranges from 5.500 to 120,000 BTU/hr, heaters that operate on either 12 volts or 24 volts, and heaters that can run on the gasoline or diesel fuel carried by the vehicle. There are various types of auxiliary coolant heaters including those that use fuel carried by the vehicle, those that have electric heater elements, and generators. An auxiliary coolant heater may alternatively or additionally be used for engine pre-heating or supplemental heating.

These supplemental heating systems, however, are not offered for use with natural gas or propane. Thus, some natural gas and propane vehicle manufactures have utilized a diesel- or gasoline-operated auxiliary heater, which does not use the same fuel type as the vehicle. Accordingly, the vehicle must have a separate fuel tank installed for the auxiliary heater's fuel.

Compressed natural gas (also called CNG herein) engine cold starts below freezing temperature are problematic due to moisture freezing and/or oil found naturally in methane restricting fuel supply/injectors. Additionally the pressure regulator 3000 psi to engine supply pressure of 125 psi may also experience freezing and/or oil blockage of the supply gas to the engine. Current vehicle engines supply heated coolant to the high-pressure regulator, but only after the engine has warmed.

Thus, natural gas- and propane-operated vehicles (such as trucks and school buses using gaseous fuels) have no means of providing “non-engine idling” pre-conditioning or pre-heating prior to vehicle use using the on-board fuel source. Likewise, during colder weather, supplemental heating during “engine on” is also unavailable in these natural gas and propane vehicles to boost heating to operator and/or passenger areas. Additionally, vehicles without an auxiliary or a supplemental heating source that are required to heat cargo, work, or passenger areas and/or to maintain operational temperatures in specific vehicle systems, such as the hydraulic systems and/or oil systems, may be rendered unoperational because the vehicles are not in a work-ready state. Current natural gas- and propane-operated vehicles typically use diesel supplemental heaters. Thus, the supplemental heater requires a second fuel tank, e.g., diesel, for use in the supplemental heater. Additional fuel tanks make these systems difficult to install and less convenient because the driver must refill two types of fuel.

One known supplemental heater for a natural gas vehicle is available for large, transit buses (available in 24 VDC only). This supplemental heater, however, is impractical for a truck or school bus application because the heat output (between approximately 100,000 and 120,000 BTU/hr) grossly exceeds the needs of a truck or school bus, would not perform correctly on a truck, school bus, etc., would short cycle, and the temperature of the heating/cooling fluid would spike rapidly. Accordingly, an incorrectly-sized supplemental heater would not work properly.

### SUMMARY OF THE INVENTION

These and other needs are addressed by the various embodiments of the present invention. Embodiments of the present invention relate to natural gas- or propane-fueled vehicles that are over-the-road vehicles (i.e., Class 8), straight trucks (i.e., Classes 6 and 7), garbage trucks, trucks used to transport cargo, trucks used in the refuse industry, trucks used in the read-mix industry, and work trucks (service industry). In some embodiments, the heater operates on 12 VDC vehicles. An appropriately-sized propane or natural gas heater would have a heat cycle that produces more even heat than a larger, incorrectly-sized heater would produce.

Embodiments of the present invention relates to a motor vehicle comprising a liquid-cooled combustion engine having ports for coolant to leave the engine and to return to the engine. Embodiments of the present invention relate to trucks, school buses, etc. running on natural gas or propane. In particular, various embodiments of the invention are directed to such trucks and school buses in which a heating system is provided by means of an internal combustion engine.

Features of the present invention may be employed in a wide range of vehicles and applications. For example, many types of vehicles are used to move cargo or passengers or provide other work truck services, such as refuse, cement, etc., and are required to provide heating to passenger compartments, temporary living quarters, or temporary working quarters. These vehicles include self-propelled, over-the-road vehicles and other vehicles with internal combustion engines, such as so-called recreational vehicles, school busses, work trucks, garbage trucks, etc. Also, self-propelled vans have been used as mobile work spaces, such as for providing medical services at remote or movable locations in a city. Other self-propelled vehicles include boats in which internal combustion engines provide the primary power source. Non-self-propelled vehicles, such as trailers, have been used to provide shelter for temporary living, such as for vacation or recreation. Also, trailers are used to provide space for performing work, such as at construction sites or performing atmospheric sensing at remote locations. All of these vehicles are characterized by the need to provide heat to a space, in the form of at least a passenger compartment.

Note that the term “supplemental” and “auxiliary” may be used interchangeably herein. The term “vehicle” is used herein to refer to all types of vehicles, whether or not self-propelled and whether an over-the-road or a water vehicle, so long as there is a space to be heated in the vehicle. The term “vehicle” also includes motor vehicles with a main power source, such as an internal combustion engine, that has the primary function of propelling the vehicle on land or water.

The main power source of such vehicle is turned off when the vehicle arrives at the destination, and reliance is placed on a supplemental source of thermal energy. Such supplemental thermal energy sources include diesel-fired and gasoline-fired burners, such as those disclosed in U.S. Pat. Nos. 2,726,042 and 3,877,639, which are incorporated by reference herein in their entireties.

Customarily, those main power sources are heated when not in operation, so that they will start readily when the vehicle is to be moved. The main power source of such vehicle is often turned off when the vehicle arrives at its destination and the vehicle relies on a supplemental source of thermal energy. Such supplemental thermal energy sources include diesel-fired and gasoline-fired burners, such as those disclosed in U.S. Pat. Nos. 2,726,042 and 3,877,639.

An improved heating system for a vehicle is described in U.S. Pat. Nos. 5,025,985 and 5,067,652 to Enander, both of which are incorporated herein by reference in their entireties. However, improvements are desirable. For example, it would advantageous if the heating system were compact, so as not to take up valuable space in a vehicle than is necessary, similar to U.S. Pat. No. 6,572,026 to Enander, which is incorporated herein by reference in its entirety. It would be advantageous for the heating system to include an efficient control system and for the heating system to provide space heating as well as optional engine heating if desired.

It is one aspect of embodiments of the present invention to provide a novel natural gas- or propane-operated heater for selectively distributing or fully distributing heat to the vehicle's occupant compartments and/or the vehicle's main engine. In some embodiments, supplemental heaters of the present invention use natural gas or propane, like the vehicle's main engine, which simplifies installation because an additional fuel tank does not need to be installed. Accordingly, heaters of embodiments of the present invention use existing on-board fuel.

Another aspect of embodiments of the present invention is to provide a supplemental heater that uses a vehicle's existing engine, engine fuel, and engine battery. Additionally, the supplemental heater will consume a low amount of power from the battery in order to not interfere with a vehicle cold start at −20° F.

It is one aspect of embodiments of the present invention to provide a supplemental heater that is reasonably compact and contains components necessary to heat and circulate engine coolant while the engine is off. Thus, the heater is compact and is packaged to utilize the space of the heater enclosure and to fit smaller vehicles (such as school buses and trucks). The heater is mounted efficiently, while still permitting access to the heater for servicing. The heater may provide heat at different selectable levels, and may be under the control of an associated control unit to maintain a set temperature. In one embodiment, when occupant compartment heating is required, a coolant pump starts circulating coolant. A supplemental heater heats the coolant as it circulates so that heated coolant flows out of the supplemental heater.

It is one aspect of embodiments of the present invention to provide a supplemental heater sized to match the heat requirement of the vehicle. The heat requirement may be determined in multiple ways. One way is:

$$Heat Requirement ( KW ) = \frac{\begin{matrix}Material Weight ( lb ) \cdot \\ Specific Heat ( BTU \text{/} lb - ° F . ) \cdot \\ Temperature Difference ( ° F . )\end{matrix}}{\begin{matrix}3412 ( BTU \text{/} KWH ) \cdot \\ Time allowed for heat \text{-} up ( hr )\end{matrix}}$$

The heat requirement may include the heat needed to preheat the engine, provide interior compartment heating, oil pan heating, fuel regulator heating, and/or hydraulic system heating. Additionally, a small percentage safety factor may be added to account for line losses in the lines that carry heat.

It is another aspect of various embodiments of the present invention to provide occupant compartment heating while keeping the engine warm when the engine is shut off after having been running.

It is yet another aspect of embodiments to provide engine pre-heating to a cold engine prior to starting the engine.

It is one aspect of embodiments of the present invention to provide a supplemental or auxiliary heater for a vehicle that is accessible from the exterior of the vehicle. Additionally, no major disassembly is required to change main heater components such as the fuel solenoid, fan motor, fuel orifice, ignition, flame detection, etc.

It is yet another aspect of various embodiments of the present invention to provide a heat source—preferably a natural gas or propane fuel-burning heat source—to heat the heat transfer medium (for example, coolant). In some embodiments, a tank agitation device may also be provided to provide efficient heat transfer to the heat transfer tank and/or fluid located within the tank. An optional heating loop may also be provided for engine preheating.

It is another aspect of embodiments to provide the fuel gas in the fuel gas supply line with a negative pressure relative to atmospheric pressure and provide a valve or switch directly adjoining the fuel gas supply line.

It is a further aspect of embodiments of the present invention to provide a system with a specific back pressure, which is not in other products on the market today. This specific back pressure holds the heat range and is an important part of the functionality of the system.

It is one aspect of embodiments of the present invention to provide a supplemental heater for a vehicle that has reduced emissions. In one embodiment, emissions are reduced by mixing the air and fuel (e.g., natural gas or propane) before the air or fuel enters the burner air-mixing tube.

Fuel-burning heaters often require some minimum cycle time in order to ignite, burn, and extinguish safely. This is called one burn cycle. The post-burn period must be long enough to clear any residual combustibles from the burn chamber before it tries to re-ignite in order to permit cool down of the heater components and to exhaust combustion byproducts from the combustion chamber. The burn time must be long enough for the burn chamber to get hot enough to clear itself of any unburned material such as fuel, smoke, or soot often caused during startup. Of course, heat is not delivered until the flame is ignited and has burned long enough to heat its immediate surroundings. This is why the burn cycle must be started earlier than non-combustion heat sources and must run for a minimum length of time without overheating before it is allowed to turn off. Thus, it is one aspect of embodiments of the present invention to provide a combination of sensors, sensor locations, and controls to achieve the desired results.

It is another aspect of embodiments to provide a supplemental heater with a device to ensure all unburnt fuel is not released into the environment. It is also an aspect of embodiments of the present invention to reduce the emission of unburned hydrocarbons in mobile heating devices. Upon shutting down the burner, typically residual fuel is still present in the fuel supply and in an inlet region of the burner. Unconsumed fuel constituents can still be present in the region of the burner. In typical mobile heating devices, usually hydrocarbon compositions are used as fuel. Thus, the remaining residual fuel and the fuel constituents typically are hydrocarbons. When the burner is inoperative, these unburned hydrocarbons may evaporate in the heating device and pass to the exterior of the heating device via the combustion air supply and the exhaust gas outlet (potentially via sound absorbers which may be provided in some embodiments).

One aspect of embodiments of the present invention is to provide a waste gas removal system, which can include a filter. To reliably prevent the discharge of waste gases via the waste gas removal system, the waste gas emission suppression arrangement associated with the waste gas removal system may comprise a closing arrangement closing a waste gas-carrying duct. Since the waste gases, on the other hand, and the waste gases being carried during the combustion operation flow through the waste gas removal system in the same direction, it is not possible, in principle, to use filter material in the waste gas removal system, because the combustion waste gases now flowing through such a filter material during the combustion operation would absorb the waste gas absorbed in the filter material and transport them to the outside into the environment. The provision of a closing arrangement rather ensures a state of the waste gas removal system that is also closed against the emission of waste gases, especially when the vehicle heating system is not in operation. To keep the volume being gradually filled with waste gases in the inoperative state as small as possible, the closing arrangement should be positioned as close to the waste gas discharge of the burner arrangement as possible. In one embodiment that can be embodied with an especially simple design, the closing arrangement may comprise a siphon unit, similar to U.S. Patent Publication No. 2014/0008449 to Eger et al., which is incorporated by reference herein in its entirety. The combustion waste gases leaving the combustion chamber can flow through this siphon unit at the pressure difference present during the combustion operation. However, since the waste gases escaping from unburned fuel cannot build up such a high pressure in the inoperative state, the siphon unit reliably ensures that waste gases cannot escape to the outside.

It is yet another aspect of embodiments of the present invention to provide a supplemental heater for vehicles that efficiently and effectively introduce air and fuel to the supplemental heater's combustion chamber, performs the combustion, and provides heat to the vehicle's coolant system.

It is another aspect of embodiments of the present invention to provide a heater that reduces wear and tear on the heater such that the heater lasts longer. Thus, the heater will maintain a constant run cycle (i.e., heat input to the vehicle), which provides even heating to the vehicle rather than a fast heat cycle, which creates a large heat input to the vehicle, followed by a quick cool down where little to no heat is provided to the vehicle.

During a normal purge stage, which may be approximately one minute to 2.5 minutes, or more specifically 90 seconds, the burner chamber, the exhaust system, and the thin jacket or coil are subjected to thermal stresses from the repeated cooling of the structure. The thermal stresses decrease the operating life of the burner and the thin jacket. Thus, it is one aspect of embodiments of the present invention to provide a method and an apparatus to overcome the above-described rapid cycling of the supplemental burner without wasting the excess heat produced by the supplemental burner.

It is another aspect of embodiments of the invention to provide quiet interior heating. Low-velocity heat exchangers provide quiet interior heating in one embodiment. Temperatures can be controlled in separate (one or more) heating areas independently. The supplemental heater can provide uniform, draft-free heating; no hot and cold air pockets. The heater provides safety features such as automatic shut-down in case of low voltage or overheat. The AC-powered electric heating element can provide heating and domestic hot water during low demand periods. The supplemental heater can use the vehicle's on-board natural gas or propane fuel, thus there is no need for propane or natural gas fuel to supply heat. The unit can provide low natural gas or propane fuel usage and low electrical DC power consumption.

One aspect of embodiments of the invention is to provide sound absorbers adapted to absorb the above described noise at the combustion air supply and/or at the exhaust gas outlet in mobile heating devices. Usually, these sound absorbers are provided outside of the actual heating device in a combustion air supply pipe and/or in an exhaust gas outlet pipe. Sound absorbers of this kind can be formed as absorption-type sound absorbers absorbing the noise or as reflection-type sound absorbers multiply reflecting and refracting the noise. Realization as an absorption-type sound absorber enables space-saving accommodation of the sound absorber. Absorbers similar to the ones described in U.S. Patent Publication No. 2011/0114741 to Kaindl, which is incorporated by reference herein in its entirety, can be used.

It is another aspect of embodiments to overcome the shortcomings of the prior art by providing a means for heating the interior of a motor vehicle having an independent electrical circuit and coolant pump that utilizes maximum latent heat usage from a shut down engine to conserve fuel. Weight sensors are provided in the seats to detect the presence of a passenger therein and activate said system once the engine is turned off. The secondary heating system of the present invention further can include a periodic shut down at preset intervals to extend battery usage. Canadian Patent No. CA 2796793A is incorporated by reference herein in its entirety.

It is one aspect of embodiments of the present invention to provide an electric auxiliary heating unit that reliably avoids temperature overshoots of the heated air. To this end, the temperature of the air flowing into the heating is determined and converted into a heating power for controlling the heating elements. This is preferably done via a stored characteristic field via which a plurality of vehicle parameters, such as the vehicle speed, the opening condition of the convertible top, etc., can be taken into account. Also, the temperature of the incoming air can be derived from temperature values which are already available in the vehicle. A user-friendly electric heating can be realized very easily in this way. Temperature fluctuations in the heated air can be avoided reliably and easily even in the case of dynamically varying operating conditions of the motor vehicle. U.S. Pat. No. 8,660,747 to Bolender et al. is incorporated by reference herein in its entirety.

In one embodiment of the present invention, a novel natural gas or propane fuel operated heater selectively distributes or fully distributes heat to the vehicle's occupant compartments and/or the vehicle's main engine. Some embodiments may also include optional added heat exchangers throughout the coolant system to distribute heated coolant from an on-board auxiliary coolant heater in a motor vehicle, such as a highway truck. In some embodiments, the heating medium (e.g., coolant) preferably contains an antifreeze, such as ethylene glycol, for example.

Some embodiments provide engine pre-heating to a cold engine prior to starting the engine. The coolant circuit also allows engine-heated coolant and/or auxiliary heater heated coolant to heat the occupant compartment(s) when the engine is running. U.S. Pat. No. 7,793,856 to Hernandez et al. is incorporated by reference herein in its entirety to provide further description and support.

In some embodiments, the coolant flow control system comprises flow paths, connecting the engine ports, the occupant compartment heater ports, and the auxiliary coolant heater ports. By selective operation of the valve assembly, the flow control system can be placed in a first state to divert the coolant flow from the auxiliary heater through the engine, and can be placed in a second state to cause the coolant to flow from the auxiliary heater outlet to the compartment heat exchangers.

In some embodiments, a gas-fired heater may be used, such as the one described in German Patent Application No. 12336683, which is incorporated by reference herein in its entirety. Typically the gas fuel is supplied to the heater with a pressure that exceeds atmospheric pressure, so that a solenoid valve triggered by an electronic control device is essential to control the gas supply.

In one embodiment, the system may also comprise a gas/fuel leak detector or gas analyzer. The leak detector should be sensitive such that it shall be able to detect a low limit of 1% LEL.

In one embodiment, a hydrocarbon storing element comprises a structure capable of being flown through having a large surface in relation to its volume. In this case, it is reliably ensured that the hydrocarbon storing element comes into contact with the evaporating unburned hydrocarbons. Formation of a large surface in relation to the volume allows space-saving, efficient storing of hydrocarbon emissions. A remarkable amount of such emissions can be stored in small space. Realization can e.g. be accomplished by open-pored porous structures, such as e.g. sponge-like or foam-like structures, fabric structures, three-dimensional grid structures, and the like. A further advantage in this case is that the hydrocarbon storing element can simultaneously serve as a sound absorbing element of a sound absorber, such as e.g. of a combustion air sound absorber or exhaust gas sound absorber. Thus, sound absorption and emission reduction can be integrated in one component.

In various embodiments, the supplementary heater may comprise a water jacket. One such water jacket is described in U.S. Pat. No. 4,300,720 to Baier et al., which is incorporated by reference herein in its entirety. The water jacket may be insulated to prevent or minimize heat from escaping the system. Further, the water jacket may be sized such that it provides for a clean burn and thus the heater's emissions a very low. In one embodiment, the water jacket may be approximately 5 to 10 inches in diameter. In a preferred embodiment, the water jacket may be approximately 6 to 9 inches in diameter. In a more preferred embodiment, the water jacket may be approximately 8 inches in diameter. Additionally, the tank within the water jacket (i.e., the tank that contains the hot gas from the combustion chamber), which may be called a heat exchanger tank herein, may be sized to further increase efficiency and reduce emissions. In one embodiment, the heat exchanger tank may be approximately 4 to 9 inches in diameter. In a preferred embodiment, the heat exchanger tank may be approximately 5 to 8 inches in diameter. In a more preferred embodiment, the heat exchanger tank may be approximately 7 inches in diameter.

In one embodiment, the water jacket can withstands operating pressure 2 bar or twice operating pressure, whichever is greatest (EC Directive 70/156/EEC). Further, the heat exchanger may be painted to withstand operating temperatures (800° F.) and environment conditions during normal use, such as cleaning chemicals found in maintenance facilities, salt mist, etc.

According to one embodiment, a valve or switch is actuated by means of a membrane that causes the fuel gas supply line to close when the fan stops or its rpm is very low. A switch of this type, configured with a membrane, can be manufactured economically. This embodiment is especially simple when the fuel gas at the fuel gas inlet opening has a negative pressure relative to atmospheric pressure of roughly 10 to 20 pa and when the membrane directly abuts the fuel gas inlet opening.

In one embodiment, the air and fuel gas are mixed in a plenum before entering the combustion chamber. In another embodiment, preparation of the combustion air/fuel gas mixture is improved by the use of a diffuser or a partition wall for swirling the mixture between the fan and the combustion chamber and by the fact that the plenum is protected from the heat radiated rearward from the combustion chamber by a heat shield or refractory. For further support and enablement, see U.S. Pat. No. 5,738,506 to Mosig, which is incorporated by reference herein in its entirety. In an additional embodiment, the air and fuel may be further mixed by a screen mesh flame tube.

In one embodiment, the fuel gas is made available in fuel gas supply line by repeatedly dropping the pressure by a pressure change Δp which is, preferably, 10-20 pa under atmospheric pressure. For this reason, when the fan stops or the fan rpm is very low, the membrane is automatically placed in front of the mouth of fuel gas supply line and blocks it.

In various embodiments, the heating system includes controls for monitoring safe operation, monitoring main power for heating system, and monitoring auxiliary methods for supply input voltages. Additional input power may be supplied from the vehicle's power source or, alternatively, grid power, which is also known as shore power or line voltage.

In some embodiments, the coolant system includes engine ports, various heat exchanger ports (in compartments such as cabs or work areas, for example), and fluid-to-fluid or fluid-to-air heat exchangers.

In one embodiment of the present invention, an auxiliary heater comprises an inlet port through which coolant enters the auxiliary heater for heating and an outlet port through which heated coolant exits the auxiliary heater.

In another embodiment, an occupant or work compartment has an interior space that is heated by a compartment heater having an inlet port through which coolant enters and an outlet port through which coolant exits.

In one embodiment, a pump may circulate the coolant from a return conduit or fluid path to a heat transfer coil. The coil receives thermal energy from the heat transfer liquid and heats the coolant. The coolant is pumped through the supply conduit to the engine where it is circulated within the engine to heat the engine to a desired temperature. When the engine is operating, the flow of coolant can be reversed to provide heated coolant to the coil for heating the liquid.

Sensors may be placed throughout the systems of embodiments at various locations. In one embodiment, the fluid, e.g. the coolant, passes the first temperature sensor, passes through the first heat transfer device and exits the auxiliary heater at an outlet. This heated fluid can be used for any appropriate purpose. While the fluid is being heated in this matter, the first temperature sensor will sense the cooler temperature of the cold inlet fluid. This low sensed temperature will cause the compartment heat exchanger circuit to be temporarily deactivated (e.g., zone pumps will be turned off) so that all the heating is directed to the heating of this cold inlet fluid. This cold inlet fluid can draw down the temperature of the heating medium quickly, because the first heat transfer device located within the tank typically has a high heat transfer capacity and the tank typically has a low volume. For example, the first heat transfer device can be a water jacket or can be about 20-40 linear feet of coiled copper. It will be appreciated that any appropriate heat transfer device (e.g., tubular, plates, etc.) can be employed. Furthermore, the system may include an ambient air thermometer that prevents operation of the supplemental heater when the ambient temperature is above a predetermined value (e.g., 45° F.) to save fuel when the heater is not required. However, this may be overridden such that an operator can turn on the heater even when the ambient temperature is above the predetermined value. The system may also include a timer, as is known in the art.

For example, a suitable temperature sensor is a mechanical snap disk manufactured by Elmwood Sensors. The mechanical snap disk is preset at a desired temperature, e.g., 120° F. When the temperature reaches or falls below the preset temperature, a disk pops out which electrically deactivates other heating circuits. For example, when the disk pops out, an electrical circuit can be broken thus turning off the zone pumps and the engine preheat pump. Other suitable deactivation devices and techniques can also be employed.

In one embodiment, the heater may comprise an orifice that leads to the combustion chamber. To ignite the fuel-air mixture, an ignition electrode is provided and is supplied with electrical energy via an ignition spark generator, which is located outside of the housing part of the combustion chamber or the water jacket. An ignition electrode extends parallel to the outer wall of the combustion chamber, which is provided with openings. In one embodiment, the spark igniter may be a 10 kV igniter. The fuel gases leave the combustion chamber on the end opposite the gas entrance, where they are reversed and discharged from the heater via an exhaust gas channel and exhaust connection. In doing so, most of the thermal energy is extracted from the exhaust gases via the heat exchanger. For this reason, water flows through a water jacket which surrounds combustion chamber and may also surround the exhaust gas channel in a spiral in counterflow, entering heat exchanger via the inlet port and leaving the heater at the outlet port.

Often in cold temperatures, the propane or natural gas engine will not start because the air intake butterfly valve freezes shut in the closed position. In various embodiments, a supplemental heater provides heat to the engine, fuel intake, manifold, and air intake valve such that the butterfly valve will defrost and open during engine start. Additionally, the engine of a vehicle may lose power while the vehicle is in route if the butterfly valve sticks due to cold temperatures. The supplemental heater eliminates this problem by providing heat to the engine, fuel intake, manifold, and air intake valve.

If outside temperatures are very cold (e.g., below −20° F.), the engine may lose power while in use and while the vehicle is in transit because condensation on the exhaust freezes and blocks the exhaust. This is due to the air at the air intake having 100% relative humidity, low temperatures on the exhaust exterior, and the fuel having a very low temperature. In some embodiments, the supplemental heater may heat the engine in order to increase the engine temperature and possibly melt the condensation on the exhaust.

In one embodiment, the associated electrical control system comprises an auxiliary heat control, a main HVAC control, a blower/temperature control, and an engine pre-heat control. The particular details of the blower/temperature control in any specific vehicle may depend on the specific vehicle. The main control may comprise controls that are available to the driver for the blower/temperature control when the vehicle is being driven, but that may also be effective in certain ways when the vehicle is not being driven and the engine is off. The auxiliary control may be either independent of or integrated with the main control. Either way, the auxiliary control may have control of the valve assembly and when the auxiliary control requests that the valve assembly be energized, the auxiliary control causes the valve assembly to be open.

With the auxiliary control off, the main HVAC controls that are accessible to the driver control the blower system and temperature of air that is heated by the heater due to flow of engine-heated coolant through the heater. The flow of heated air is directed by an air distribution system that may take any of various forms for distributing the heater air inside a vehicle compartment. The air may be distributed for any one or more of windshield defrosting, driver's compartment heating, and sleeper compartment heating when the truck has a sleeper compartment.

An over-temperature sensor may be provided for the burner and an over-temperature sensor may be provided for the electric heater. These two sensors will shut down the burner and electric heater, respectively, if an over-temperature is reached (e.g., 140° F., 190° F., or 240° F.). This provides a back-up safety feature to prevent overheating. A low-water cutoff switch may also be provided to shut down operation of the heater in the event that the heating medium falls below a minimum level. This is yet another safety feature.

In some embodiments, to supply the thermal load of compartment (room air) heat exchangers, a vehicle is provided with the auxiliary heating system having a peak thermal output of about 40,000-50,000 BTU/hr. The auxiliary system may include a propane or natural gas-fired burner. In one embodiment, the burner is a burner manufactured by Webasto AG having a thermal output of approximately 45,000 BTU/hr. Such a burner is normally shipped with a combustion chamber in the form of a closed horizontal cylinder having an air/fuel inlet at one end and an exhaust pipe at the other end.

In various embodiments, a propane-fuel supplemental heater is equipped with an AC electric heating element. The heater may provide both coolant heating and domestic water heating. The heater may include two or more thermostatic heating zones, two or more zone heating circulation loops, one or more cozy heat exchangers, bay heating, electronic controllers, over 50,000 BTU/hr output. The heater may use AC shore power for light-duty heating and hot water use. The heater may also use propane fuel for heating in colder temperatures and to provide continuous hot water.

In one embodiment, a motor vehicle is provided comprising: fluid; an engine comprising a first port through which the fluid can leave the engine and a second port through which the fluid can return to the engine, wherein the engine is one of a propane-operated engine and a natural gas-operated engine; a first heat requirement that is heated by a compartment heater having an inlet port through which the fluid enters, an outlet port through which the fluid exits, and a heat exchanger; an auxiliary coolant heater system comprising: an inlet port through which the fluid enters the auxiliary coolant heater system for heating; an outlet port through which heated fluid exits the auxiliary coolant heater system; a blower; a combustion chamber comprising an igniter and a burner tube; a plenum; a heat transfer medium; and an exhaust; and a coolant flow control system comprising: a first flow path that connects the compartment heater inlet port, the compartment heater outlet port, the auxiliary coolant heater inlet port, and the auxiliary coolant heater outlet port such that the first flow path provides for the fluid to flow from the auxiliary coolant heater outlet port through the compartment heater and back to the auxiliary coolant heater inlet port; a second flow path that connects the engine first port, the engine second port, the auxiliary coolant heater inlet port, and the auxiliary coolant heater outlet port such that the second flow path provides for heated fluid to flow from the auxiliary coolant heater outlet port to the engine second port to heat the engine; and a fluid pump. In an additional embodiment, the auxiliary coolant heater system may operate on at least one of propane and natural gas. Furthermore, the heat transfer medium may be a tank that encases at least a portion of the fluid around the combustion chamber. Alternatively, the heat transfer medium may be copper tubing comprising the fluid, wherein the copper tubing is positioned proximate to the combustion chamber

In one embodiment, a motor vehicle heating system is provided comprising: an engine comprising a first port through which a fluid leaves the engine and a second port through which the fluid returns to the engine, wherein the engine is one of a propane-operated engine and a natural gas-operated engine; a compartment heater having an inlet port through which the fluid enters, an outlet port through which the fluid exits, and a heat exchanger; an auxiliary coolant heater system comprising: an inlet port through which the fluid enters the auxiliary coolant heater system; an outlet port through which heated fluid exits the auxiliary coolant heater system; a blower; a combustion chamber comprising an igniter and a burner tube; a plenum; a heat transfer medium; and an exhaust port; and a coolant flow control system comprising: a first flow path that interconnects the compartment heater inlet port, the compartment heater outlet port, the auxiliary coolant heater inlet port, and the auxiliary coolant heater outlet port such that the first flow path provides for the coolant fluid to flow from the auxiliary coolant heater outlet port through the compartment heater and back to the auxiliary coolant heater inlet port; a second flow path that connects the engine first port, the engine second port, the auxiliary coolant heater inlet port, and the auxiliary coolant heater outlet port such that the second flow path provides for heated coolant fluid to flow from the auxiliary coolant heater outlet port to the engine second port to heat the engine; and a fluid pump. In some embodiments, the first flow path is in fluid communication with the compartment heater inlet port, the compartment heater outlet port, the auxiliary coolant heater inlet port, and the auxiliary coolant heater outlet port and the second flow path is in fluid communication with the engine first port, the engine second port, the auxiliary coolant heater inlet port, and the auxiliary coolant heater outlet port.

In some embodiments, the coolant flow control system may further comprise a valve assembly having a first state and a second state. Additionally, the vehicle engine may be a liquid-cooled combustion engine. In alternative embodiments, the coolant fluid may be a mixture of water and coolant.

In one embodiment, an auxiliary coolant heater system for a vehicle is provided comprising: coolant fluid; an inlet port through which the coolant fluid enters the auxiliary coolant heater system for heating; an outlet port through which heated coolant fluid exits the auxiliary coolant heater system; a blower; a combustion chamber comprising an igniter and a burner tube; a plenum; a water jacket; an exhaust; a first flow path for the heated coolant fluid that connects the outlet port to an inlet port of at least one of a vehicle engine, a compartment heat exchanger, a hydraulics heat exchanger, a fuel regulator, and an oil pan heat exchanger, a second flow path for the heated coolant fluid, wherein the second flow path connects the outlet port to an in-line heater, and wherein the in-line heater is interconnected to the vehicle engine; and a fluid pump.

In some embodiments, the water jacket surrounds a heat exchanger tank, wherein the heat exchanger tank surrounds the combustion chamber, and wherein coolant fluid is positioned between the water jacket and the heat exchanger tank such that the coolant fluid is in a heat transfer relationship with the heat exchanger tank and the water jacket.

In one embodiment, a method of heating a vehicle engine is provided comprising: providing coolant fluid; providing an engine comprising a first port through which the coolant fluid can leave the engine and a second port through which the coolant fluid can return to the engine, wherein the engine is one of a propane-operated engine and a natural gas-operated engine; providing a first heat requirement that is heated by a compartment heater having an inlet port through which the coolant fluid enters, an outlet port through which the coolant fluid exits, and a heat exchanger; providing an auxiliary coolant heater system comprising: an inlet port through which the coolant fluid enters the auxiliary coolant heater system for heating; an outlet port through which heated coolant fluid exits the auxiliary coolant heater system; a combustion chamber comprising an igniter and a burner tube; a heat transfer medium; and an exhaust; providing one or more flow paths; burning a mixture of air and at least one of propane fuel and natural gas fuel in the combustion chamber; transferring heat from the combustion air-fuel mixture to the heat transfer medium; transferring heat from the heat transfer medium to at least one of the engine, a compartment, a hydraulic system, an oil pan, and a fuel regulator.

In one embodiment, a method of manufacture is provided. The method comprises: placing combustion tubes on the fixture and installing the alignment plug, placing the fins in the fixture, tacking the top side of fins in place, removing the alignment plug and combustion tube assembly from the fixture, rotating the combustion tube assembly and attacking the bottom side of the fins in place followed by each slot in the fin, welding the fins into the tube, tacking the end cap onto the tube assembly, and welding the end cap onto the tube assembly. The method may further include tacking a coupler to the exhaust tube, welding the coupler to the exhaust tube, tacking the exhaust tube assembly to the combustion tube assembly, welding the exhaust tube assembly to the combustion tube assembly, performing a first leak check, and performing a second leak check. The method may also include tacking the combustion chamber tube to the flange, welding the flame tube flange stud holes closed, and welding the combustion chamber tube to the flange. In one embodiment, the method includes tacking a helix to the heat exchanger tube, removing a exhaust tab from the water jacket tube, installing the heat exchanger tank in the water jacket, tacking the exhaust steam, tacking the exhaust tab to the water jacket tube, welding the exhaust tab seams, welding the exhaust port seam, placing mounting feet in the fixture, placing the end cap in the fixture, placing the water jacket assembly in the fixture, placing a mounting flange in the fixture, and tacking the mounting feet to the heat exchanger and water jacket assembly. In some embodiments the method includes tacking an end cap on the water jacket tube, tacking a mounting flange on the heat exchanger tank and water jacket assembly, welding studs to the flange, welding an end cap onto the water jacket tube, welding a mounting flange on to the heat exchanger tank and water jacket assembly, welding the backside of the mounting flange to the water jacket assembly, taking an inlet and an outlet ports to the water jacket, welding the inlet and outlet ports to the water jacket, welding a thermostat mount to the water jacket, and removing all excess spatter from the assembly. The water jacket may further be manufactured by installing test fittings, doing a first leak check, performing a second leak check, removing the test fittings, cleaning the heat exchanger tank, masking the heat exchanger tank, painting the heat exchanger tank, and removing the mask from the heat exchanger assembly. The electronics may be manufactured and assembled into the system through the steps of: inserting control thermostat terminal in one or more connector and install a wedgelock, installing control thermostats, crimping terminals, inserting hi-limit thermostat terminal and installing a wedgelock, installing hi-limit thermostats, installing a first combustion chamber gasket, installing the combustion chamber inside the heat exchanger, and installing a second combustion chamber gasket. The method may also include installing an over inlet hose, installing grommets, installing an inlet formed hose, installing clamps on the inlet formed hose, installing pump suction hoses, fastening grounds and a ground strap to a ground stud, and fastening an amphenol connector to the enclosure wall. The method may include fastening a harness and a ground trap to the enclosure, placing the water jacket assembly in the enclosure base, riveting the water jacket to the enclosure, installing clamps, installing an outlet hose, installing a dust cover on the pump, and inserting pump wire terminals in a connector. The method may include manufacturing the plenum by tacking and welding components together, such as the baffle, the plenum front half, the plenum back half, the mixing tube, the flame tube, the burner, the burner mount flange, and the igniter mount block. Further, various components of the system may be tested for functionality. In some embodiments, wires, valves, connectors, and compression fittings may be installed. The heater or burner may be manufactured by fastening a burner premix head to a burner mount flange, installing a refractory igniter insulation element, fastening a flame sensor to a burner mount flange assembly, setting the flame sensor spacing, fastening a flame igniter to the burner mounting flange, installing a small hose barb in the plenum, installing a gas orifice fitting in an orifice holder, and applying a thin layer of grease to the orifice holder flange. Further, the method may include fastening a orifice holder flange to the plenum, drilling and taping a hole in the blower or fan casing, installing a small hose barb in the blower casing, installing studs in the blower mounting flange, fasting air shutter to the blower mounting flange, and fastening the blower to the air shutter assembly bracket. Then air shutter assembly may then be fastened to the plenum. The method of manufacture may include installing clamps, suction hoses, and other items on the pump. Additionally, the bottom pressure switch may be fastened to the enclosure wall and connecting tube may be installed. In one embodiment, a switch and an electrical component box is fastened to the enclosure wall and the igniter is interconnected to an igniter cable. In some embodiments, a timer is installed and a low voltage disconnect is installed in the system. Additional inlet ports, outlet ports, and tubing may also be installed in some embodiments. Domestic hot water heaters and other heat exchangers may be installed in the system in further embodiments. In one embodiment, a regulator is installed and a nipple is stalled in the nipple regulator. The method may also include installing a gas valve into the system.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

Those of skill in the art will recognize that the following description is merely illustrative of the principles of the present invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1A is a flow diagram showing one embodiment of a vehicle engine's cooling system;

FIG. 1B is an alternate embodiment of a section of the flow diagram of FIG. 1A;

FIG. 2 is a flow diagram showing a second embodiment of the vehicle engine's cooling system;

FIG. 3 shows the heat transfer options in an embodiment of a heat exchanger;

FIG. 4 shows an embodiment of the electrical, controlling, and monitoring of the vehicle heater and associated systems;

FIG. 5 is perspective view of a vehicle provided with a heating apparatus for providing supplemental thermal energy for occupant compartment air and main engine heating;

FIG. 6A is a front elevation view of an embodiment of a supplemental heater;

FIG. 6B is a cross-sectional view of the supplemental heater of FIG. 6A taken at cut A-A;

FIG. 7A is a front elevation view of a second embodiment of a supplemental heater;

FIG. 7B is a perspective view of section B-B of the supplemental heater of FIG. 7A;

FIG. 7C is a front elevation view of a third embodiment of a supplemental heater;

FIG. 7D is a perspective view of section D-D of the supplemental heater of FIG. 7C;

FIG. 8 is an embodiment of a vehicle heating system that includes a supplemental heater and one or more heat exchangers;

FIG. 9 is an embodiment of a compartment heat exchanger system;

FIG. 10A shows a single closed-circuit supplemental heater;

FIG. 10B shows a single closed-circuit supplemental heater interconnected to a vehicle engine;

FIG. 11 is a front right perspective view of a fourth embodiment of a supplemental heater;

FIG. 12 is a front left perspective view of the supplemental heater of FIG. 11;

FIG. 13 is a front right perspective view of the supplemental heater of FIG. 11 shown without the water jacket;

FIG. 14 is a top plan view of the supplemental heater of FIG. 11;

FIG. 15 is a bottom plan view of the supplemental heater of FIG. 11;

FIG. 16 is a front right perspective view of the supplemental heater of FIG. 11 with an enclosure;

FIG. 17 is a rear left perspective view of the supplemental heater of FIG. 16;

FIG. 18 is a front elevation view of a fifth embodiment of a supplemental heater with an exhaust pipe;

FIG. 19A is a perspective view of one embodiment of a heater;

FIG. 19B is a perspective view of a second embodiment of a heater;

FIG. 20 is a top perspective view of one embodiment of a multi-circuit supplemental heating system;

FIG. 21 is an exploded perspective view of an embodiment of a single-circuit supplemental heater;

FIG. 22 is an exploded perspective view of an embodiment of a triple-circuit supplemental heater;

FIG. 23 is a flow chart of the operation of a supplemental heater according to one embodiment;

FIG. 24 is a chart showing the cycling of a supplemental heater according to one embodiment;

FIG. 25 is a flow chart of a vehicle's coolant system without a supplementary heater;

FIG. 26 is a flow chart of a vehicle's coolant system with a supplementary heater;

FIG. 27A shows a dual closed-circuit supplemental heater;

FIG. 27B shows a dual closed-circuit supplemental heater interconnected to a vehicle engine;

FIG. 28A shows a triple closed-circuit supplemental heater; and

FIG. 28B shows a triple closed-circuit supplemental heater interconnected to a vehicle engine.

To assist in the understanding of the embodiments of the present invention the following list of components and associated numbering found in the drawings is provided herein:

Item Name
1 Exhaust
2 Vehicle
3 Supply Conduit
4 Return Conduit
5 Heater Conduit
6 Heated Fluid Outlet Port
7 Fuel Valve and Pressure Regulator
8 Blower
9 Air Inlet
10 Coolant Path to Engine
11 Flame Tube
12 Coolant Path Engine Outlet to Fuel Regulator
13 Outlet
14 Coolant Outlet Port
15 Fuel Entry
16 Vehicle Engine
17 Zone
18 Compartment Heat Exchanger
19 (First) Heat Load
20 Coolant Path to Engine
21 Secondary Fuel/Air Mixing
22 Coolant Inlet Port
23 Coolant Return Path from Fuel Regulator
24 Coolant Path in Fuel Regulator
25 (Heated) First Outlet Port
26 Conduit or Heated Fluid Path
27 Inlet Port (of the Heat Exchanger)
28 Coolant Solenoid Valve
29 Inlet
30 Fuel Tank (Propane/Natural Gas)
31 Coolant Pump Inlet Port
31A Coolant Outlet
31B Coolant Outlet
31C Coolant Outlet
32 Engine Coolant Pump
32 Engine Coolant Pump Inlet
33 Heater (Coolant) Outlet Port
34 Air Delivery Location
35 Exiting Port
36 Auxiliary Power
37 Fuel-Air Mixture Delivery Point
38 Conduit or Heated Fluid Path
39 Inlet
40 Heat Load
41 Outlet
42 Fluid Outlet
43 Coolant Reservoir (Fluid Tank); Water Jacket
44 Fuel Regulator
45 Coolant Fill Point
46 Point (Regulated Fuel Supply for Engine)
47 Charging Source
48 Engine Coolant Outlet Port
49 Return Coolant Port
50 Voltage Source
51A Heated Fluid Circuit
51B Heated Load Circuit
52 Fuel Solenoid Valve
53 Monitoring
54 Directional Flow Valve
55 Coolant Pump
56 Electric Heating Element
57 Inlet Port
58 Outlet Port
59 Heat Exchanger Tank
60 (Auxiliary) Heater (Coolant) Inlet Port
61 Combustion Flame Area
62 Fuel Solenoid
63 Coolant Pump
64 Engine Coolant Inlet Port
65 (Internal) Coils
66 Inlet
67 Fluid Pump
68 Fuel Delivery
69 Fuel Solenoid
70 Tube
71 (Fluid-to-Fluid or Fluid-to-Gas) Fuel Heat Exchanger
72 Coolant Pump
73 Coolant (Circulation) Pump
74 Combustion/Exhaust Path
75 (Heated Fluid) Inlet Port
76 Return Coolant Path(s)
77 Engine (Coolant) Outlet Port
78 Exiting Port
79 Spark Igniter
80 (Heated Fluid) Outlet Port
81 First Flow Control Solenoid Valve
82 (Natural Gas- or Propane-Operated) (Supplemental or Auxiliary) Heater
83 Entering Port
84 Engine (Coolant) Outlet Port
85 Point (Regulated Fuel Supply for Heater)
86 Heated Load Circuit Outlet
87 Second Flow Control Solenoid Valve
88 Primary Fuel/Air Mixing Location
89 Spiral
90 Plenum
91 Entering Port
92 System Controls
93 End Piece
94 Fuel Orifice
95 Donut (Refractory)
96 Fins
97 Fuel Connection
98 Thermostat
99 Coolant or Fluid
100 Fluid to Fluid Heat Exchanger
100A Heated Fluid Flow/Circuit
100B Heated Load Circuit
101 Combustion Chamber
102 Outlet
103 On Signal
104 Flame Sensor
105 Partition
106 Enclosure
107 Pressure Sensor
108 Voltage Monitor
109 Maintenance Switch
110 First Heat Zone Outlet
112 Second Heat Zone Outlet
114 First Heat Zone Inlet
116 Second Heat Zone Inlet
118 Engine Preheat Inlet
120 Engine Preheat Outlet
122 Engine Preheat Circulation Pump
124 Control Thermostat
200 Burner Assembly
202 Exhaust
204 Gas Regulator
206 On/Off/Time 3-Position Switch
208 7-Day Timer
210 Engine Preheating
212 Oil Pan
214 Fuel Pressure Regulator
216 Hydraulics Reservoir
218 Operator Cabin Exchanger
220 Heat Zone Outlet 1
222 Heat Zone Outlet 2
224 Heat Zone 1 Return
226 Heat Zone 2 Return
227 Engine Preheat Circulation Pump
228 Engine Preheat Inlet
230 Engine Preheat Outlet
232 Zone Circulation Pumps
234 Fuel Inlet Outlet
236 Burn Chamber
238 Electric Heating Element
240 Thermal Storage Tank
242 Cold Water In
244 Cold Water Out
246 Water Tempering Valve
250 Cargo/Work Box
252 Water/Fluid Tank

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

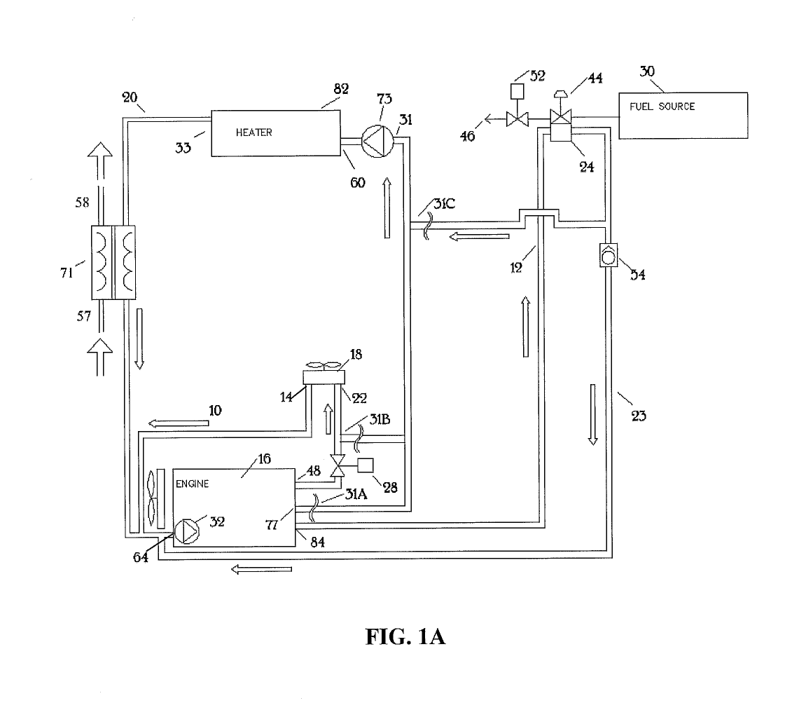

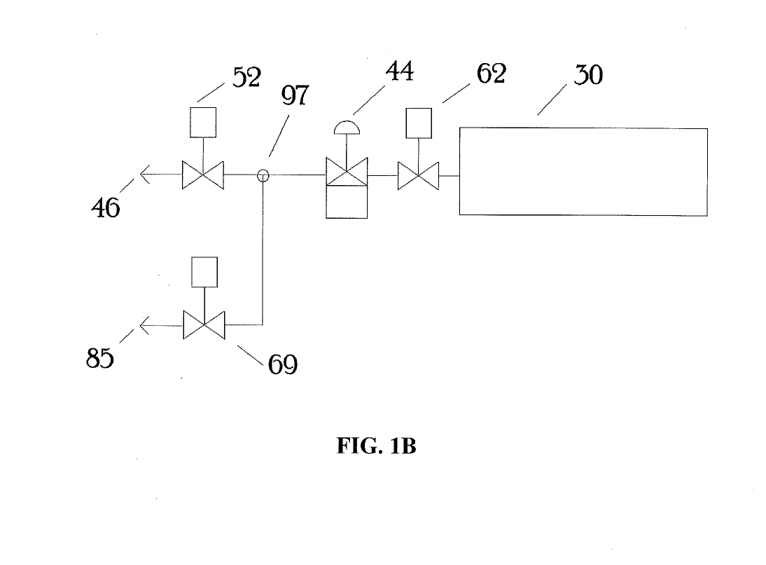

FIG. 1A is a flow diagram showing one embodiment of a vehicle engine cooling system. More specifically, FIG. 1A shows the fluid flow circuits of a vehicle engine cooling system. Note that the fluid flow circuits may also be referred to as “systems” and “circuits” herein. In some embodiments, the vehicle engine cooling system comprises multiple fluid flow circuits, for example: a vehicle compartment heat exchanger circuit, a natural gas circuit, an engine coolant circuit, etc. The vehicle engine cooling system of FIG. 1A comprises an engine 16, a compartment (also called a “cab” herein) heat exchanger 18 for compartment heating, a coolant path 12, 23 for heating a fuel regulator 44, and a natural gas- or propane-operated supplemental heater 82.

The compartment heat exchanger 18 may be a heat exchanger through which fluid is circulated and have a blower system for moving air across the liquid-to-air heat exchanger to deliver heated air to the occupant compartment. The compartment heat exchanger 18 may also provide heat for the driver's compartment, for the sleeper compartment, or for both, depending on the particular vehicle model. In some embodiments, the compartment heat exchanger 18 comprises a coolant inlet port 22 through which coolant enters the compartment heat exchanger 18, a coolant outlet port 14 through which coolant exits the compartment heat exchanger 18, and a coolant path 10 from the compartment heat exchanger 18 to the engine 16. A coolant solenoid valve 28 may also be placed between the first engine outlet port 48 and the inlet port 22 of the compartment heat exchanger 18 to shut off flow if, for example, the air conditioner is on.

In some embodiments, the inlets and outlets may be ¼ inch i.d. hoses. Alternatively, the inlets and outlets may be ½ inch i.d. hoses. In a further embodiment, the inlets and outlets may be any combination of ¼ inch i.d. hoses and ½ inch i.d. hose.

The engine 16 has two ports—a first engine coolant outlet port 48 and an engine coolant inlet port 64—that provide for the vehicle compartment heat exchanger 18 to associate with the engine 16. The first engine coolant outlet port 48 is at an engine coolant supply (pressure) side of the engine 16 and delivers heated coolant to the rest of the system. The engine coolant inlet port 64 is at an engine coolant return (suction) side of the engine 16, where coolant returns to the engine 16. The engine 16 may have an engine coolant pump 32 associated with the engine coolant inlet port 64 to create the suction needed to circulate the coolant.

In some embodiments, the engine 16 cooling/heating system also comprises a fuel (e.g., natural gas) regulator 44, a coolant path 24 in the fuel regulator 44, a coolant return path 23 from the fuel regulator 44, and a coolant path 12 to the fuel regulator 44 from a second engine outlet port 84. The engine 16 (or supplemental heater 82, in some embodiments) provides heat to the fuel regulator 44 to manage the fuel regulator 44 temperature at the point where the pressure of the fuel drops from a high pressure to a low pressure for engine 16 use (i.e., fuel source). Without a heating system, the drop in pressure across the regulator 44 is so significant that it would cause some fuel types to freeze and prevent operations (e.g., LPG, CNG, LNG). Thus, the engine 16 also has two ports associated with the fuel (e.g., natural gas or propane) circuit: the second engine coolant outlet port 84 and an engine coolant inlet port 64. These ports 84, 64 provide heated coolant to a natural gas regulator 44. The second engine coolant outlet port 84 is at an engine coolant supply (pressure) side of the engine 16, which delivers heated coolant to the regulator 44 by flowing through the coolant path 12 from the second engine outlet port 84 to the regulator 44 and through the coolant path 24 in the fuel regulator 44. The other port 32 is at an engine coolant return (suction) side where coolant returns to the engine 16.

A fuel tank 30 is interconnected to the regulator 44 so that as the fuel leaves the fuel tank 30, the pressure of the fuel is reduced to a pressure that the system can handle. The fuel then flows through a fuel solenoid valve 52, which opens when the ignition is on, thus providing fuel for the engine. At point 46 the fuel supply is now regulated for the engine 16 and flows toward the engine 16.

If the vehicle is used in a location with an extremely cold climate, then a fluid-to-fluid or fluid-to-gas fuel heat exchanger 71 may be included between the fuel solenoid and the engine 16 to heat the fuel prior to entry into the engine 16. The fuel heat exchanger 71 may be located in series with the engine cooling system or in a branch circuit (shown in FIG. 1A). In some embodiments, the fuel heat exchanger 71 may be interconnected to the engine 16 for heating. Thus, the regulated fuel would enter the fuel heat exchanger 71 at inlet port 57 and exit the fuel heat exchanger 71 through an outlet port 58. No other auxiliary or supplemental heater on the market heats the fuel (e.g., natural gas or propane) prior to the fuel entering the engine. One such heat exchanger 71 known in the art is the Arctic Fox natural gas and alternative fuel heat exchanger (http://www.arctic-fox.com/fuel-fluid-warming-products/alternative-fuel-warming), which is incorporated by reference herein.

When the engine 16 is running, it can supply engine-heated coolant to the compartment heat exchanger 18 and a coolant path 24 in the natural gas regulator 44. When the engine 16 is not running, or if the engine is running but is operating in extremely cold temperatures, an auxiliary or supplemental heater 82 is available for supplying heated coolant to the engine 16, fuel regulator 44, and/or compartment heat exchanger 18. Note that the heater 82 may be called an “auxiliary heater,” a “supplemental heater,” or a “heater” herein. The heater 82 may comprise a pump 73 for circulating engine coolant when the engine 16 is not running and/or when the heater 82 is switched on. The pump 73 may be a self-contained pump and have a pump inlet port 31. The pumps 73, 32 circulate the engine coolant throughout the system. In one embodiment, the coolant pump 73 to the heater outlet port 33 location, which achieves the same result for flow through the heater 82 and the fuel regulator 44. Coolant enters the auxiliary heater 82 through a heater inlet port 60 and exits the heater 82 through a heater outlet port 33. The engine also 16 has two ports 77, 64 that are associated with the heater 82: a third engine coolant outlet port 77 and an engine coolant inlet port 64. The third engine coolant outlet port 77 is at an engine coolant supply (pressure) side that delivers coolant to the heater 82. The engine coolant inlet port 64 is at an engine coolant return (suction) side where coolant returns to the engine 16 from the heater 82 through a coolant path 20. The heater 82 provides heated coolant output priority to the engine 16, because the hottest fluid is supplied to the engine 16.

Vehicle heating priority or simultaneous heating to the compartment heat exchanger 18 and the fuel regulator 44 may further be controlled by the heater 82 location and may interconnect to the compartment heat exchanger 18 or the fuel regulator 44 through the connection from a coolant outlet 31A, 31B or 31C to the pump inlet port 31 or from the heater outlet port 33 to the coolant outlet 31B. Some embodiments may also include a flow directional valve or check valve 54 in line with any of the previous mentioned circuits or flow paths to ensure correct coolant flow direction in through the coolant path 24 in the fuel regulator 44.

When the engine 16 is off and the heater 82 is on, coolant flow is started by pump 73. Coolant is heated through coolant path 20 and through the engine 16, then coolant exits engine 16 via coolant path 12. Next, heated coolant heats fuel regulator 44 by flowing through the coolant path 24 and then returns to the heater 82 via the coolant outlet 31C and coolant pump inlet 31 to establish a full circuit of heated fluid. The flow directional valve 54 ensures flow through this flow path and prevents fluid flow through coolant path 23.

When the engine 16 is on and the heater 82 is on or off, the system has increased power/flow due to the engine coolant pump 3. Thus, the same flow as described above with the engine 16 off is applicable except that the coolant path 23 will begin to flow fluid and coolant path 31C will flow in the reverse direction due to the increased power of the engine coolant pump 32. Coolant path 12 will continue to see coolant flow due to the low fluid flow restriction.

FIG. 1B is an alternate embodiment of a section of the flow diagram of FIG. 1A. In FIG. 1B, the fuel exits the fuel tank 30 and enters a fuel solenoid valve 62, which may be the vehicle's existing fuel solenoid valve. In various embodiments, the fuel solenoid valve 62 may be positioned either before or after the fuel regulator 44. When the heater 82 or engine 16 calls for fuel, the fuel solenoid valve 62 will open such that fuel may flow to the heater 82 or engine 16. In some embodiments, the fuel solenoid valve 62 may be integrated into the vehicle fuel distribution box. The fuel then flows through the fuel regulator 44 before reaching a fuel connection 97, which is a safety point. At the fuel connection 97, the fuel may flow to a first fuel solenoid valve 52 and then to the engine 16 through point 46 or the fuel may flow to a second fuel solenoid valve 69 and then to the heater 85 through point 85 where the fuel is regulated to approximately 125 psi.

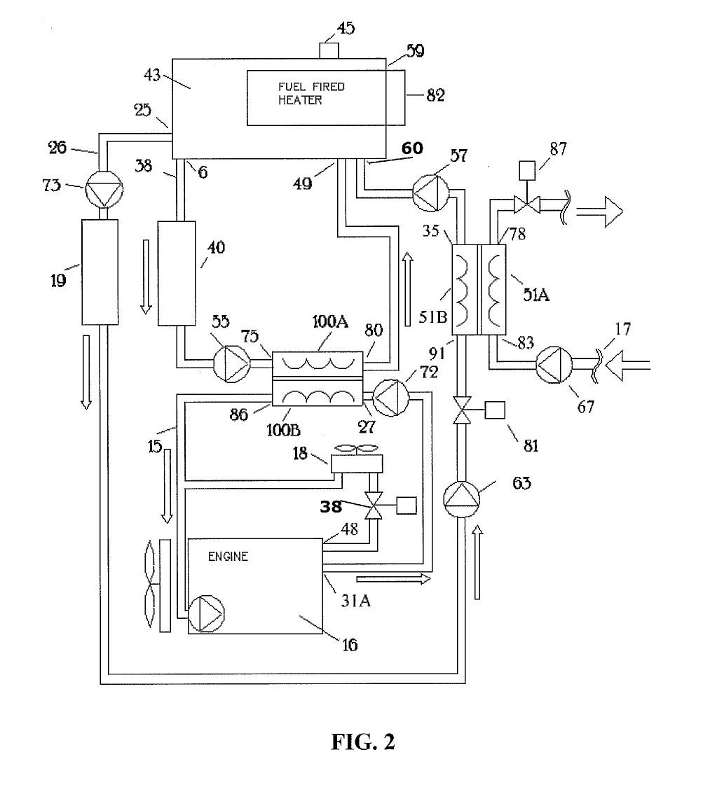

FIG. 2 is a flow diagram showing a second embodiment of the vehicle engine's cooling system, which includes a coolant reservoir or fluid tank 43, which may also be called a water jacket. The engine's cooling system may comprise an optional heater 82 with a fuel-operated heat exchanger in a coolant reservoir 43. The coolant reservoir 43 may be insulated (not shown) in some embodiments to increase the efficiency of the heater system. The additional coolant reservoir 43 provides heat to the various fluid circuits and systems such that the fluid circuits may be heated together or heated in isolation from one another. In another embodiment, the heater 82 is outfitted with a larger heat exchanger 59, which is also referred to as a heat exchanger tank or a tank. The heat exchanger tank 59 may be a cylindrical shape or any other shape, such as square or rectangular. This embodiment provides isolation from direct contact to the existing vehicle systems. Further, the heater 82 may further be constructed to facilitate several fluid inlets 23, 49, 45 and several fluid outlets 25, 6. The vehicle engine's cooling system may function with the above description of the heater 82 (shown in FIGS. 1A, 2, and 3), standalone without the reservoir 43, or with a heat exchanger tank 59 around the heater 82 heat exchanger. The coolant reservoir 43 may also comprise a coolant fill point 45, with or without a pressure cap. The coolant reservoir 43 may also be integrated into the various circuits.

In each fluid circuit, fluid flow control is accomplished by the circuit's coolant pump 73, 55, 72, 63, 57, 67 by either a switch-on for heating or a switch-off for no heating. This circuit zone control utilizes the heaters' 82 heated fluid for the preference or priority circuit to heat.

FIG. 2 illustrates the separation of the engine's primary coolant circuit by means of a fluid-to-fluid heat exchanger 100A, 100B and separation by fluid-to-fluid heat for an engine heating/cooling circuit and a heater circuit. Thus, there may be one path 38 for heated fluid flow 100A for the heater circuit and a separate path 100B for the engine heating/cooling circuit. The engine 16 may comprise a coolant outlet 31A for providing heated coolant to an inlet port 27 of the heat exchanger 100A,B. The heat exchanger 100A,B also has an outlet port 86 interconnected to the engine 16 through a flow path 15. The engine heating/cooling circuit may be associated and/or interconnected to a compartment heating circuit comprising a compartment heat exchanger 18 and a coolant solenoid valve 28 positioned between a first engine outlet port 48 and the compartment heat exchanger 18 to shut off flow of heated coolant if, for example, the air conditioner is on.

The heater circuit may comprise a path 38 for heated fluid flow 100A through a heat exchanger 100A,B, a heat load 40, a pump 55, a heated fluid inlet port 75 on the heat exchanger 100A,B, a heated fluid outlet port 80 on the heat exchanger 100A,B, a return coolant port 49 on the heater 82 or on the tank 59, and a heated fluid outlet port 6 on the heater 82 or tank 59.

A heat load circuit is a glycol-based fluid system that has a first heat load 19 and a conduit or fluid path 26 exiting the coolant reservoir 43 at a first outlet port 25. The heat load circuit feeds heat exchanger 51A, 51B comprising an entering port 91 and an exiting port 35. The fluid then returns to the heater 82 via a heater inlet port 60. The heat exchanger 51A,B may be a fluid-to-fluid heat exchanger or a plate-to-plate heater exchanger. Advantages of a plate-to-plate heat exchanger are that the fluid for one system or circuit (e.g., zone 17) is not required to be the same type of fluid as the fluid in the other system or circuit (e.g., the heat load circuit). Fluid in a zone 17 enters a heater exchanger 51A,B by movement of the fluid from the activation of a pump 67. The fluid enters the heat exchanger 51A,B through an inlet port 83 and exits through an outlet port 78. The fluid in zone 17 may be hydraulic fluid, domestic-potable or non-potable water, oil, etc. In some embodiments, the hydraulic fluid warmers may need about 4,000 to 10,000 BTU/hr to operate. Examples of hydraulic tank warmers include those made by Arctic Fox. Cab heat exchangers may need about 6,000 to 8,000 BTU/hr to operate. Thus, in some embodiments, a domestic hot water heat exchanger is provided for heating domestic water. Furthermore, the pump 67 would exchange with the requirements of the necessary flow and fluid requirements of zone 17. A first flow control solenoid valve 81 is shown in heat load circuit to ensure the heated fluid ends in the heat exchanger 51A,B. The first flow control solenoid valve 81 may be closed, for example, in summer months to ensure no heated coolant flows to heat the hydraulic fluid, if zone 17 is the hydraulic circuit. A second flow control solenoid 87 provides protection in zone 17 in the event zone 17 requires isolation from the heat exchanger 51A,B.

FIG. 2 illustrates two heat loads 19, 40 for design purposes, only. Other embodiments may include a system with numerous different heat loads (also called heat requirements). Heat loads may include, are not limited to, liquid-to-air heat exchangers, fluid-to-fluid heat exchangers, radiant heaters, and emersion heaters, to name a few.

In additional embodiments, one or more different heat transfer mediums as previously described may be installed. Further, the inlet ports and outlet ports are not limited to the specific number shown and may also be reduced or increased.

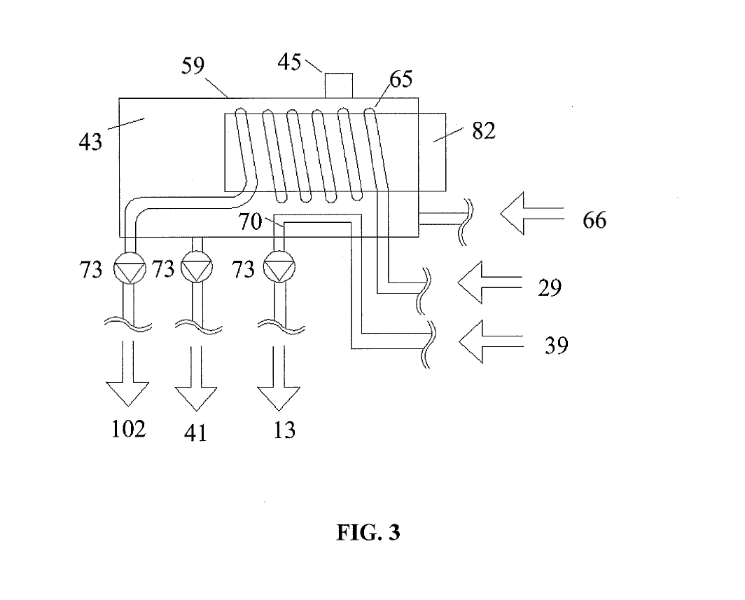

FIG. 3 shows the heat transfer options in an embodiment of a heat exchanger. Further, the heater 82 may further be constructed to facilitate several fluid inlets 20, 39, 66 and several fluid outlets 13, 41, 102.

FIG. 3 expands on the innovative solutions for isolating the vehicle heating requirement systems. Thus, the heater 82 is outfitted with a larger heat exchanger tank 59, thereby providing a novel method of containing the heat exchangers inside the tank 59 to heat the heated fluid or coolant in the coolant reservoir. The heated fluid in the tank 59 may transfer heat to internal coils 65 wrapped around the hot portion of the heater 82, or may transfer heat to a tube 70 or coil 65 passing through the tank 59. Fluid entering the tank 59 through the inlet 66 is mixed and heated in the tank 59. The heated fluid is driven by a fluid pump 73 when it exits the tank 59 through the outlet 41 to return heated fluid to a system or circuit. Fluid entering the inlet 66 and exiting the outlet 41 is not by means of a tube, but rather the tank 59 is part of an isolated system from the tube 70 and coils 65. The coils 65 are secured, such as by brazing, in a serpentine path or in a circular path to the outer side of the heater 82 so that the fluid in the coil 65 is in heat transfer relationship with the liquid in the tank 59. Fluid enters the coils 65 through an inlet 29 and exit the coils 65 through an outlet 102. Fluid in a tube 70 enters the heater 82 or heat exchanger through inlet 39 and exits the heater 82 or heat exchanger through outlet 13.

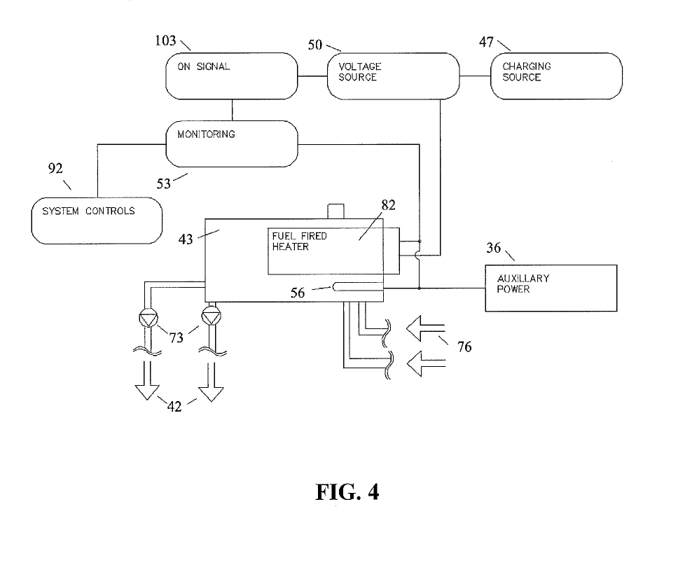

FIG. 4 shows an embodiment of the electrical, controlling, and monitoring of the vehicle heater and associated systems. The diagram also illustrates an added heat source 82 connected to the water jacket or reservoir 43. Fluid to be heated enters the heater 82 at inlets 76 and heated fluid exits the heater at outlets 42. The system may also include pumps 73 to circulate the fluid. The system of FIG. 4 may include a charging source 47 (such as a vehicle alternator or inverter 110/220 VAC to 12 or 24 VDC), a voltage source 50 (12 VDC or 24 VDC), an on signal 103 (which may include controls such as a timer, switches, an ambient thermostat, etc. to activate the heater 82), monitoring 53 for the safe starting, operation, and shutdown of the system, system controls 92 to control components outside of the heater enclosure (e.g., coolant pumps, status lights, blower, heat exchanger, coolant solenoid valves, fuel solenoid valves, etc.), and auxiliary power 36 for supplying voltage for electrical heating elements.

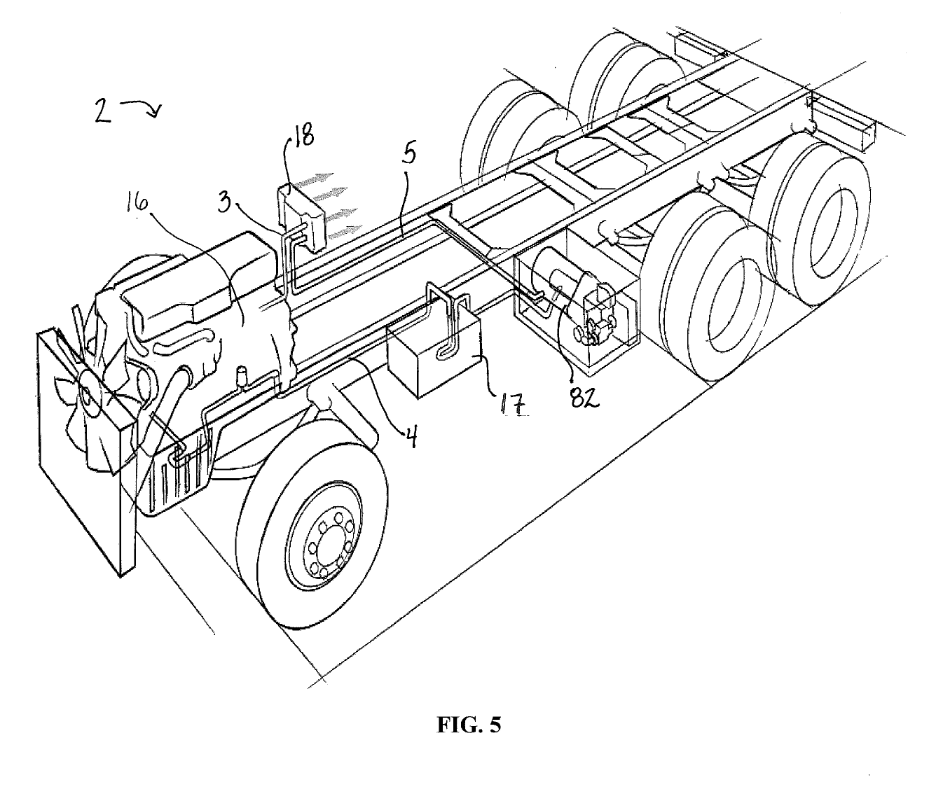

FIG. 5 is perspective view of a vehicle 2 provided with a heating apparatus for providing supplemental thermal energy for occupant compartment air and main engine heating. When assembled, a fluid-tight system is provided for the engine coolant or other heating/cooling fluid. The vehicle 20 may be propelled by an engine 16. As described above, the vehicle 20 may also be in the form of a boat, in which event the engine 16 propels the boat on the water. The vehicle 2 may also be a trailer that is towed by another self-propelled vehicle.

The engine 16 may be an internal combustion engine or other type of engine having a liquid coolant system for maintaining the engine 16 at a desired operating temperature. Preferably, when the vehicle 2 is being propelled by the engine 16, thermal energy is supplied via a conduit 3 that carriers heated engine coolant to a compartment heat exchanger 18 and/or to an auxiliary heater 82. Cooled coolant is returned to the engine 16 via a return conduit 4. When the engine 16 is not operating, the engine 16 can optionally be maintained at a desired temperature by supplying heated engine coolant from the auxiliary heater 82 to the engine 16 via the return conduit 4. Additionally, heated coolant may be provided to a zone 17 to heat additional requirements, such as oil, domestic water, hydraulics, etc.

In the various forms of the vehicles, separate spaces or rooms can be provided for various living or working activities. In each room, at least one liquid-to-air heat exchanger 18 is provided for heating the room air to a desired temperature. These heat exchangers 18 may be of a standard type known as fan convectors. Heat transfer liquid is supplied to the heat exchangers 18 from the engine 16 (or heater 82 in alternate embodiments) by supply conduit 3 and is returned to the heater by heater conduit 5.

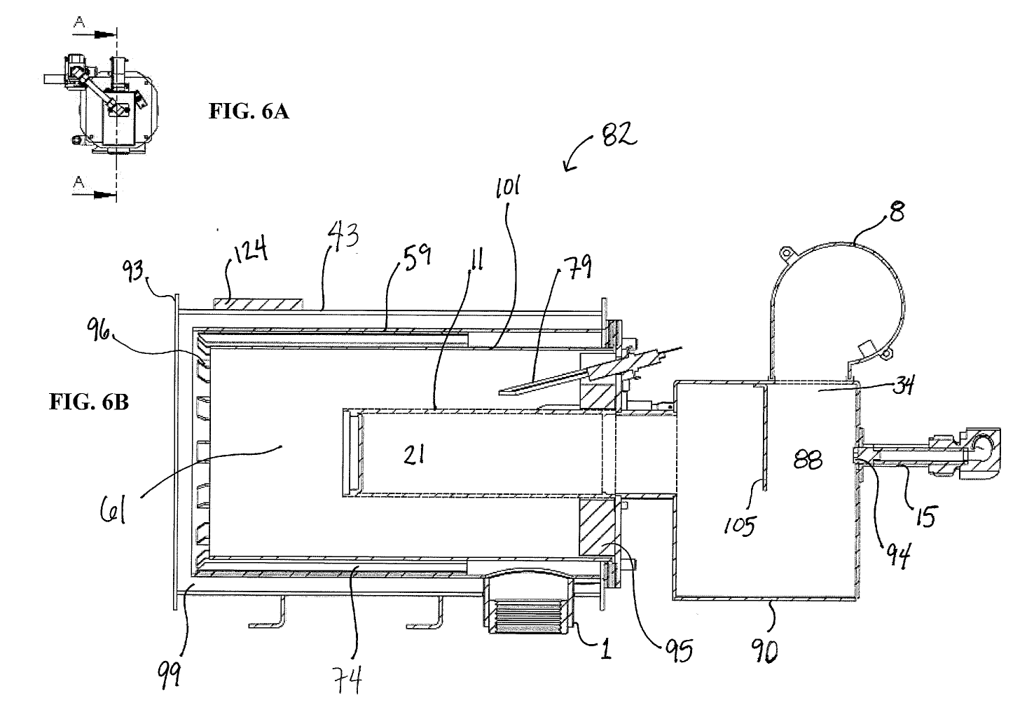

FIG. 6A is a front elevation view of an embodiment of a supplemental heater. FIG. 6B is a cross-sectional view of the supplemental heater of FIG. 6A taken at cut A-A. The heater 82 may comprise a blower 8 to blow air from an air inlet (not shown) into a plenum 90 at an air delivery location 34 where the air mixes with the fuel at a primary fuel/air mixing location 88. In one embodiment, the plenum volume is between about 94.5 and 115.5 cubic inches (which may also be the primary air/fuel mixing controlled volume). In a preferred embodiment, the plenum volume is about 105 cubic inches. In one embodiment, the air may enter the plenum 90 at about 50 to 60 CFM. In another embodiment, the combustion air may enter the plenum 90 at between about 10 and 20 CFM. In a first preferred embodiment, the combustion air enters the plenum 90 at between about 12 and 17 CFM (for example, for a propane heater). In a first more preferred embodiment, the combustion air enters the plenum 90 at between about 14 and 16 CFM (for example, for a propane heater). In a second preferred embodiment, the combustion air enters the plenum 90 at between about 11 and 16 CFM (for example, for a natural gas heater). In a second more preferred embodiment, the combustion air enters the plenum 90 at between about 12 and 15 CFM (for example, for a natural gas heater).

In some embodiments, the fuel enters the plenum 90 through a fuel entry 15 and a fuel orifice (also called a nozzle herein) 94. In one embodiment, the fuel may enter the plenum 90 at a pressure between about 3 and 5 inches water column. In a preferred embodiment, the fuel may enter the plenum 90 at a pressure of about 4 in. w.c. (approximately 0.145 psi), which results in the fuel entering the plenum 90 at about 0.94 cubic feet per minute. In an alternate embodiment, the fuel may enter the plenum 90 at a pressure between about 8 in. w.c. and 13 in. w.c. In one embodiment, the fuel content volume is between approximately 20 and 26 cu.ft. and the fuel content quality is between about 2,000 and 3,000 BTU cu.ft. (for example, for a propane heater). In a preferred embodiment, the fuel content volume is between approximately 20.5 and 25.5 cu.ft. (for example, for a propane heater). In a more preferred embodiment, the fuel content volume is about 22 cu.ft. and the fuel content quality is approximately 2,516 BTU cu.ft. (for example, for a propane heater). In a second embodiment, the fuel content volume is between approximately 45 and 65 cu.ft. (for example, for a natural gas heater). In a preferred embodiment, the fuel content volume is between approximately 50 and 60 cu.ft. (for example, for a natural gas heater). In a more preferred embodiment, the fuel content volume is about 56 cu.ft. and the fuel content quality is between about 900 and 1,100 BTU cu.ft. (for example, for a natural gas heater).

The plenum 90 has a partition 105 to route the fuel-air mixture toward the combustion chamber 101 and to further encourage mixing at the primary fuel/air mixing location 88. In one embodiment, the air and fuel mix within the plenum 90 at a pressure between about 0.25 and 0.65 in. w.c. and the pressure within the combustion chamber 101 is between approximately 0.25 and 0.6 in. w.c., which creates a back pressure at the entrance of the combustion chamber 101 (for example, for a propane heater). In a preferred embodiment, the air and fuel mix within the plenum 90 at a pressure between about 0.55 and 0.6 in. w.c. and the pressure within the combustion chamber 101 is between approximately 0.3 and 0.4 in. w.c., which creates a back pressure at the entrance of the combustion chamber 101. In a second embodiment, for example, for a natural gas heater, the air and fuel mix within the plenum 90 at a pressure between about 0.25 and 0.60 in. w.c. and the pressure within the combustion chamber 101 is between approximately 0.15 and 0.5 in. w.c., which creates a back pressure at the entrance of the combustion chamber 101. In a second preferred embodiment, the air and fuel mix within the plenum 90 at a pressure between about 0.35 and 0.45 in. w.c. and the pressure within the combustion chamber 101 is between approximately 0.2 and 0.3 in. w.c., which creates a back pressure at the entrance of the combustion chamber 101.

In one embodiment, the minimum air to fuel concentration percentage that permits ignition is between about 4.4% and 5.1%. In one embodiment, the maximum air to fuel concentration percentage that permits ignition is between about 15% and 17%. In a preferred embodiment, the air to fuel concentration percentage should be between approximately 5.1% and 15%. The air-fuel mixture then enters a flame tube 11 within a combustion chamber 101 where secondary fuel/air mixing 21 occurs. In one embodiment, the flame tube 11 is between approximately 6.5 and 8.5 inches long, as measured from the point of interconnection to the water jacket 43 to the end of the flame tube 11 within the combustion chamber 101. In a preferred embodiment, the flame tube 11 is between approximately 7 and 8 inches long. In a more preferred embodiment, the flame tube 11 is approximately 7.5 inches long. The majority of the flame tube 11 may be a mesh material to further promote the mixing of the fuel and the air. However, parts of the flame tube 11 may be solid. One example of a mesh-like flame tube is the Worgas TEXI premix burner. An igniter 79, which may be an electronic spark igniter, sparks a flame in the combustion flame area 61 such that the air-fuel mixture burns in the flame tube 11. In embodiments using natural gas, the igniter is often a spark igniter. In embodiments using propane, the igniter is often a hot surface igniter. A donut or refractory 95 is positioned behind the spark igniter 79 to prevent the gases from flowing backwards within the combustion chamber 101. The refractory 95 is a solid tube that removes gas from behind the igniter 79 tip. This makes the area behind the source of the ignition (e.g., spark igniter 79) flat and sealed, which stabilizes the pressure and the gas flow and removes turbulence at the ignition source 79 tip. The hot gases exit the combustion flame area 61 along the combustion/exhaust path 74, which is between the combustion chamber 101 and a heat exchanger tank 59, and then out the exhaust 1. In one embodiment, the volume of the heat exchanger tank 59 is between about 390 and 470 cubic inches. In a preferred embodiment, the volume of the heat exchanger tank 59 is about 430 cubic inches. In one embodiment of the present invention, the heating system performance can be improved increasing the surface area of the heat exchanger tank 59. Thus, the heat exchanger tank 59 may have fins 96 to increase the speed and amount of heat transfer to the fluid 99 contained between the heat exchanger tank 59 and the coolant reservoir 43 (i.e., fluid tank). The fins may be painted white to scrub heat off of the gas. The fins 96 increase the surface area of the tank, which increases heat transfer. The combustion chamber 101 transfers the heat of the flame and combustion to the fluid in the coolant reservoir 43. The coolant reservoir 43 may have an end piece 93 interconnected to the structure of the coolant reservoir 43. If the coolant reservoir 43 is cylindrical, then the end piece 93 will be circular to fit the coolant reservoir 43 shape. When assembled, a fluid-tight tank (i.e., the coolant reservoir 43) is provided for the coolant. Additionally, a control thermostat 124 on the water jacket 43 may be provided to measure the temperature of the water jacket 43. The control thermostat 124 may include a bimetal switch in some embodiments. In some embodiments, the thermostat may be puck spot welded to the top of the water jacket 43.

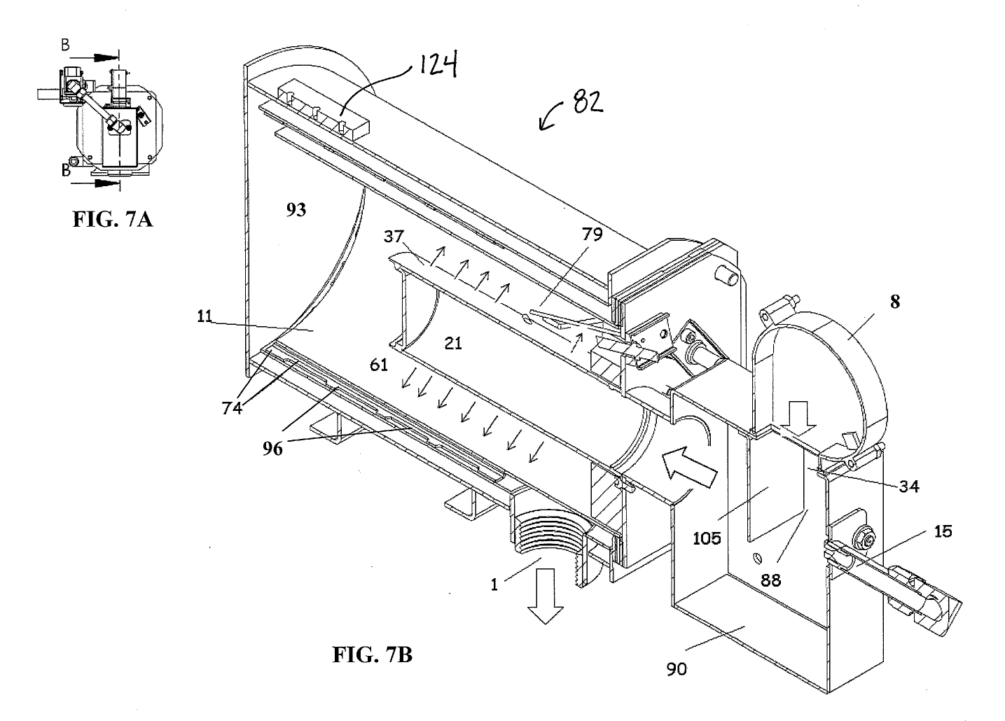

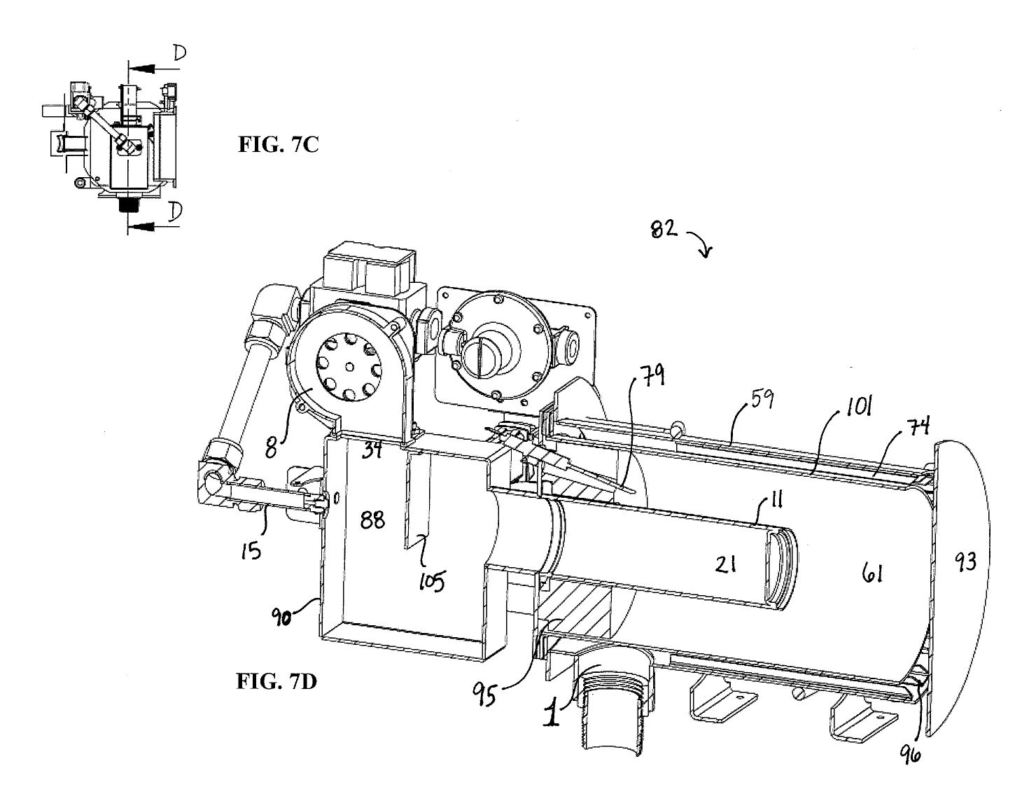

FIG. 7A is a front elevation view of a second embodiment of a supplemental heater and FIG. 7B is a perspective view of section B-B of the supplemental heater of FIG. 7A. The numbering used in FIG. 7B correlates to the numbering used in FIG. 6B. Additional arrows are shown in FIG. 7B to indicate the direction of the gas flow. Additionally, the flame tube 11 promotes further mixture of the fuel and air by using a mesh screen in some embodiments. Thus, the fuel-air mixture is delivered to the combustion chamber 101 at delivery points 37. Furthermore, the exhaust 1 may include threads to interconnect or detachably secure an exhaust pipe (not shown) to the exhaust 1.

FIG. 7C is a front elevation view of a third embodiment of a supplemental heater and FIG. 7D is a perspective view of section D-D of the supplemental heater of FIG. 7C. The numbering used in FIG. 7D correlates to the numbering used in FIGS. 6B and 7B. However, the embodiment shown in FIG. 7D is slightly different from the embodiment shown in FIG. 7B. For example, the refractory 95 in FIG. 7D is thicker/wider than the refractory in FIG. 7B. The larger refractory 95 of FIG. 7D removes more gas from behind the igniter 79 tip than the smaller refractory 95 of FIG. 7B. This makes the area behind the ignition source 79 flatter and the pressure and gas flow at the ignition source 79 tip more stable than the thinner refractory 95. In one embodiment, the combustion chamber 101 has a volume of between about 240 and 280 cubic inches. In a preferred embodiment, the combustion chamber 101 has a volume of between about 255 and 265 cubic inches. In a more preferred embodiment, the combustion chamber 101 has a volume of about 262 cubic inches.

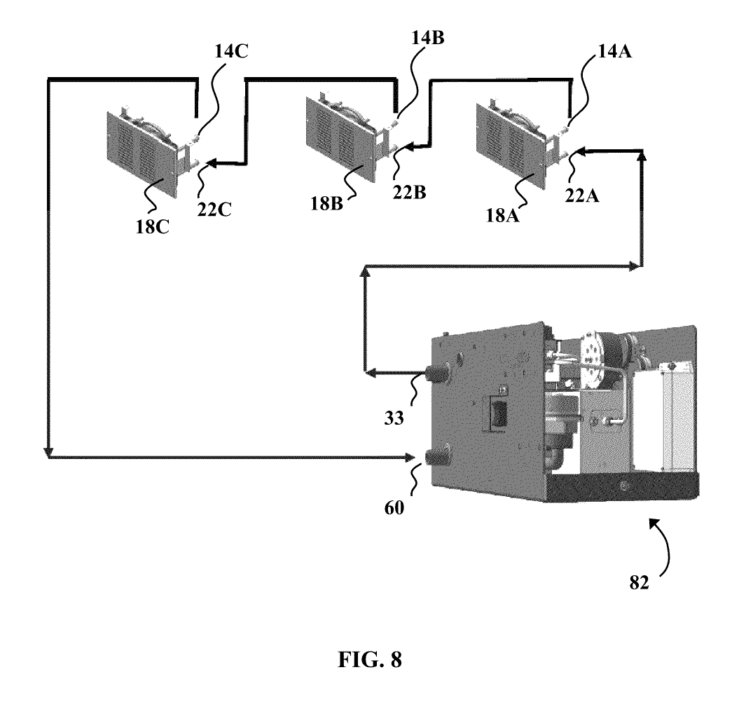

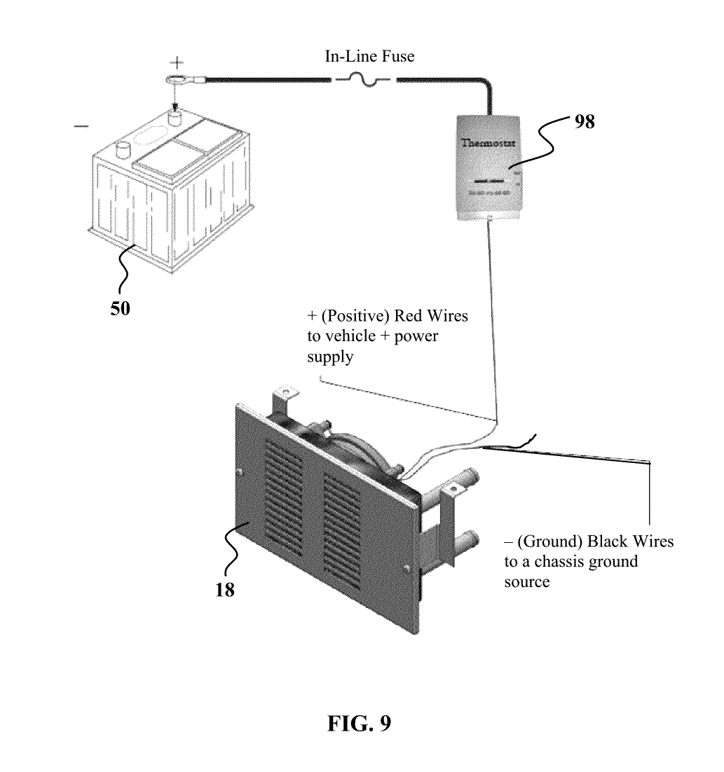

FIG. 8 is an embodiment of a vehicle heating system that includes a supplemental heater 82 interconnected to one or more compartment heat exchangers 18A, 18B, 18C. In the embodiment shown, heated coolant flows out of the heater 82 through a heated outlet port 33 and into a first compartment heat exchanger 18A through a first coolant inlet port 22A. The coolant then exits the first compartment heat exchanger 18A through a first coolant outlet port 14A and enters a second compartment heat exchanger 18B through a second coolant inlet port 22B. The coolant then exits the second compartment heat exchanger 18B through a second coolant outlet port 14B and enters a third compartment heat exchanger 18C through a third coolant inlet port 22C. After the coolant exits the third compartment heat exchanger 18C through a third coolant outlet port 14C, the cooled coolant returns to the heater 82 through a heater inlet port 60. The heat exchangers 18A-C may be any type of heat exchanger, but are preferably fluid-to-air heat exchangers such that heated engine coolant or other liquid may circulate through the heat exchangers 18A-C and heat from the fluid can be transferred to air blowing across the heated fluid and blow into a compartment of the vehicle.

FIG. 9 is an embodiment of a compartment heat exchanger system. In the embodiment shown, the compartment heat exchanger 18 is interconnected to a voltage source 18, which may be the vehicle battery. A thermostat 98 is positioned between the compartment heat exchanger 18 and the voltage source 50 such that a switch within the thermostat 98 may allow the compartment heat exchanger 18 to receive power from the voltage source 50 when the ambient temperature is below a predetermined minimum and the thermostat 98 may not allow the compartment heat exchanger 18 to receive power from the voltage source 50 when the ambient temperature is above a predetermined maximum.

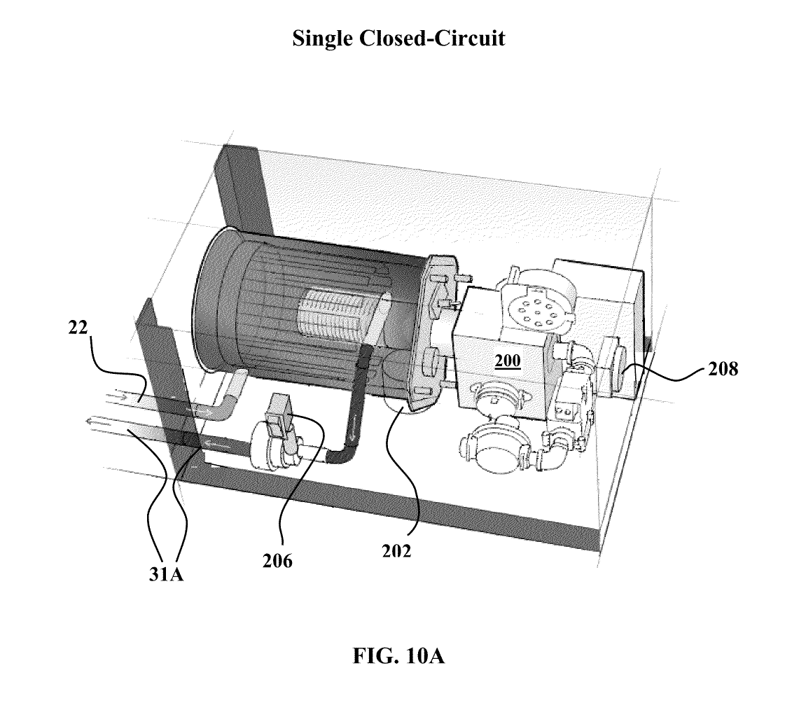

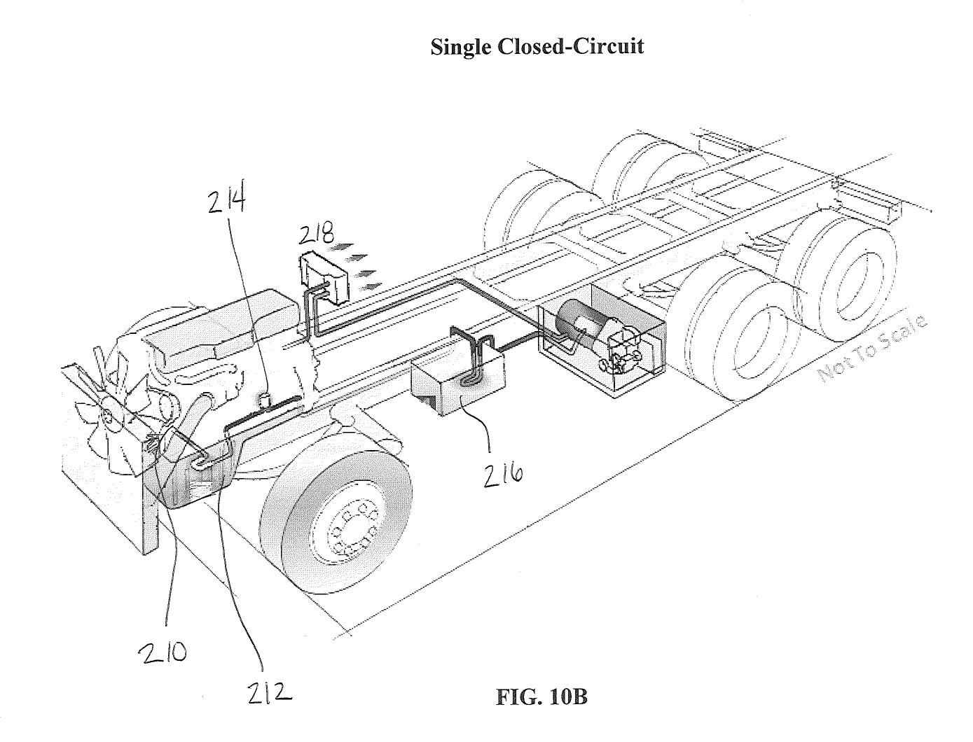

FIG. 10A shows a single closed-circuit supplemental heater comprising a burner assembly 200, and exhaust 202, a gas regulator 204, a 3-position switch (on/off/time) 206, a 7-day timer 208, a coolant outlet 31A, and a coolant inlet 22. FIG. 10B shows the single closed-circuit supplemental heater interconnected to a vehicle engine. The system comprises engine preheating 200, an oil pan 212, a fuel pressure regulator 214, a hydraulics reservoir 216, and an operator cabin exchanger 218. The heater provides heat to the engine, oil pan 212, fuel pressure regulator 214, hydraulics reservoir 216, and operator cabin exchanger 218.

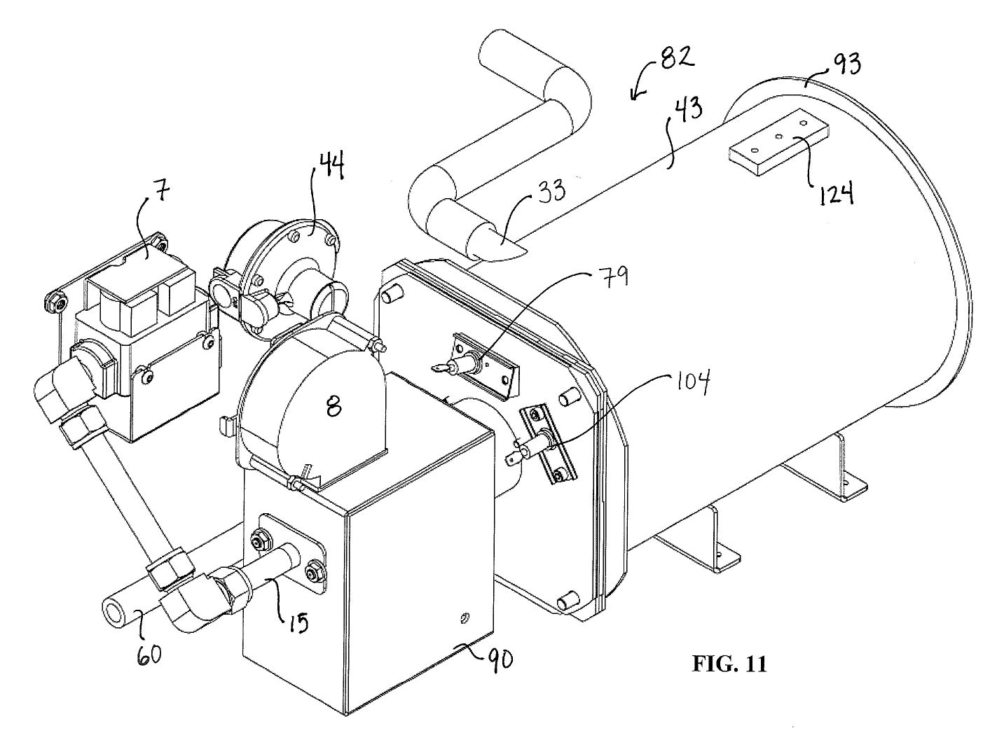

FIG. 11 is a front right perspective view of a fourth embodiment of a supplemental heater 82. The heater 82 and heater system may include a coolant reservoir 43 to provide a medium for one or more coolant paths and devices to be heated. The coolant reservoir 43 has an end piece 93, a coolant outlet port 33 where coolant heated by the combustion chamber (not shown) exits the heater 82, and a coolant inlet port 60 where coolant to be heated enters the heater 82. In some embodiments, the inlet port 60 is located on the bottom or lower side of the coolant reservoir 43 and the outlet port 33 is located on the top or upper side of the coolant reservoir 43 because heated coolant rises and because gas or air bubbles rise and move the liquid with bubbles. The heater also has a control thermostat 124 on the water jacket 43 to measure the temperature of the water jacket 43 or the fluid within the water jacket 43. In some embodiments, the coolant reservoir 43 may be encased or encircled in insulation to increase the efficiency of the heater and reduce heat loss to the environment. The heater 82 also comprises a flame sensor 104 (only the end is shown) and a spark igniter 79 (only the end is shown). The igniter 79 may be a two-wire electrode or other igniter known in the art, including a hot surface igniter. In one embodiment, the positions of the flame sensor 104 and the spark igniter 79 are switched. The heater 82 further comprises a regulator 44 to reduce the pressure of the fuel from 125 psi to 0.5 psi, a redundant fuel valve and pressure regulator 7 to reduce the pressure from 0.5 psi to 4 inch w.c. (water column), a fuel entry 15 into a plenum 90, and a blower 8 to blow air into the plenum 90 and to blow the fuel-air mixture into the combustion chamber. In other embodiments, the redundant fuel valve and pressure regulator 7 may reduce the pressure from 0.5 psi to between 8 and 13 in. w.c.

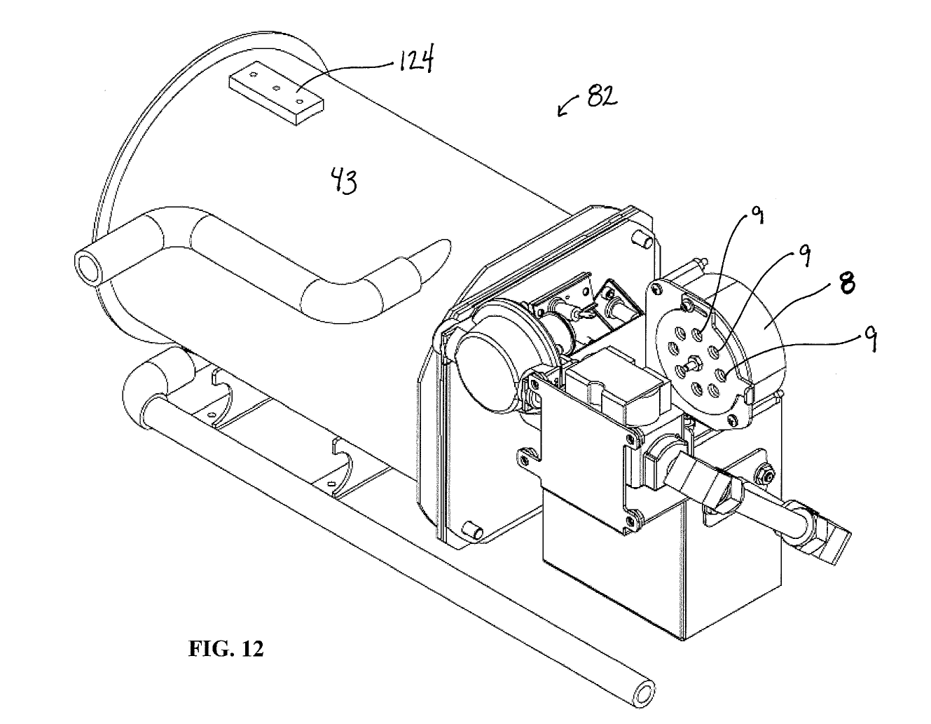

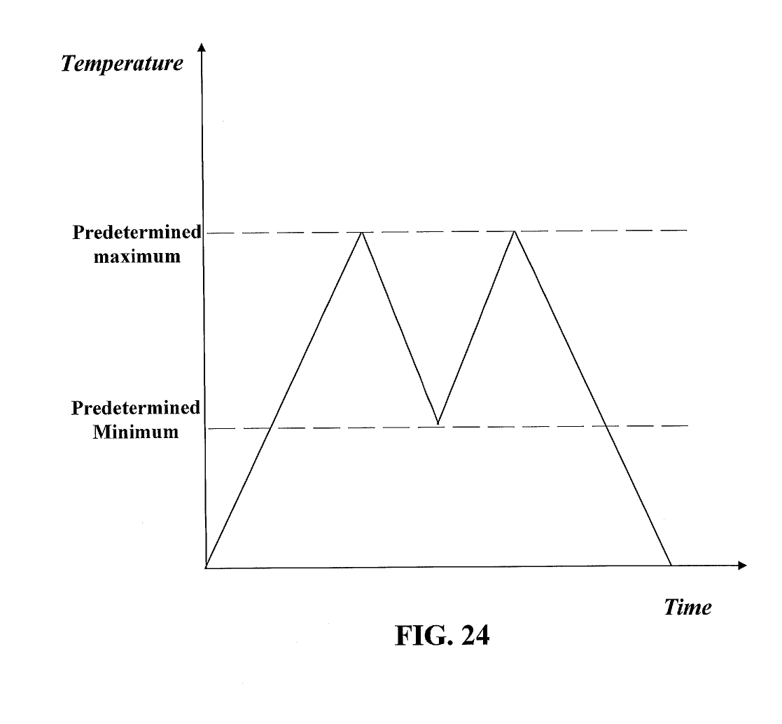

FIGS. 12-19B show different views of the heater 82 shown in FIG. 11. The components shown and/or numbered in FIGS. 12-19B correlate to the components shown and/or numbered in previous figures. In the interest of brevity, the component names and numbers will not be repeated for FIGS. 12-19B. FIG. 12 is a front left perspective view of the heater 82. The air inlet 9 in the blower 8 can be seen in this view. Additionally, a control thermostat 124 on the water jacket 43 measures the temperature of the liquid in the water jacket 43 in one embodiment and the control thermostat 124 measures the temperature of the water jacket 43 itself in another embodiment. In alternative embodiments, the control thermostat 124 measures either the fluid entering the water jacket 43, the fluid exiting the water jacket 43, or both. As is discussed below in FIG. 24, the burner (i.e., flame tube, combustion chamber, burner, etc.) of the heater 82 cycles on and off depending on the temperature measured by the control thermostat 124.

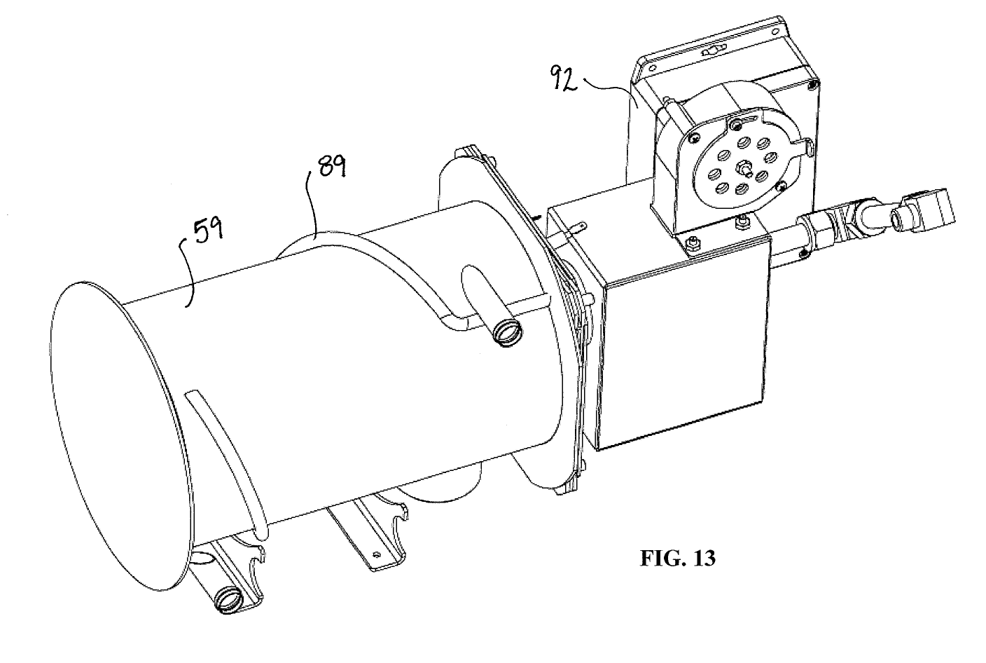

FIG. 13 is a front right perspective view of the heater 82 shown without the water jacket 43. In one embodiment of the present invention, the heating system performance can be improved by agitating the water in the water jacket 43 to enhance heat transfer. A fin or spiral 89 on the outside of the heat exchanger tank 59 induces helical flow of the fluid around the heat exchanger tank 59 so that more heat will transfer from the combustion chamber and heat exchanger tank 59 to the coolant or fluid flowing around the tank 59 within the water jacket 43. The fins or spiral 89 are secured to the heat exchanger tank 59, for example by brazing, in a serpentine path or in a circular path within the water jacket 43 so that the water or coolant in the water jacket 43 is in heat transfer relationship with the heat exchanger tank 59. In another embodiment, the spiral 89 may be a helix spot-welded. In additional embodiments, the spiral 89 may be tighter wound such that it encircles the tank 59 more times, the spiral 89 may be looser wound, or the tank 59 may comprise more than one spiral 59. Additionally, the controls 92 are shown in FIG. 13. The controls 92 are contained within an enclosure to protect the circuitry of the controls 92. The controls 92 control the heater 82 operation.

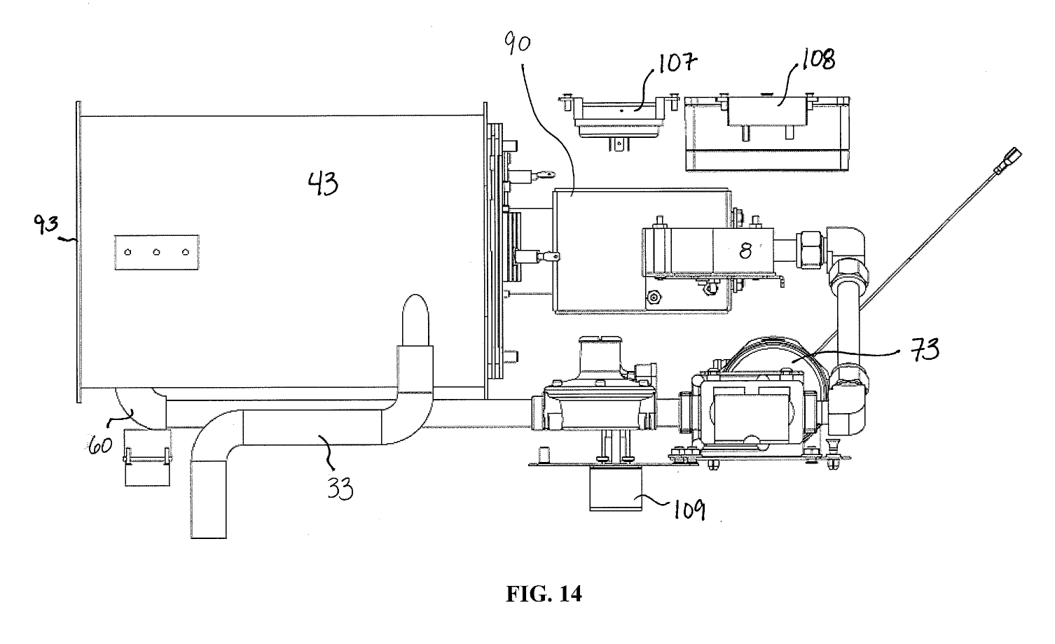

FIG. 14 is a top plan view of the heater 82. The heater 82 further comprises a pressure sensor 107, which is connected by a small tube to the combustion air and/or the blower motor. The pressure sensor 107 is detecting a pressure between approximately 0.10 inch w.c. and 0.18 inch w.c. In one embodiment, the pressure sensor 107 detects a pressure of about 0.14 inch w.c. The pressure sensor 107 is a safety that ensures the blower 8 is operational prior to permitting gas to enter the combustion chamber. A back pressure switch may also be incorporated into the pressure sensor 107. The heater 82 may also comprise a voltage monitor 108, which can be set between approximately 9.5 and 11.5 VDC or it can be set in a “no monitor” position. The voltage monitor 108 includes a low voltage disconnect such that if the voltage drops below the set point, the heater will switch off to protect the vehicle's battery from draining. The heater also comprises a coolant circulation pump 73 and an on/off maintenance switch 109 mounted to the heater 82 enclosure (not shown).

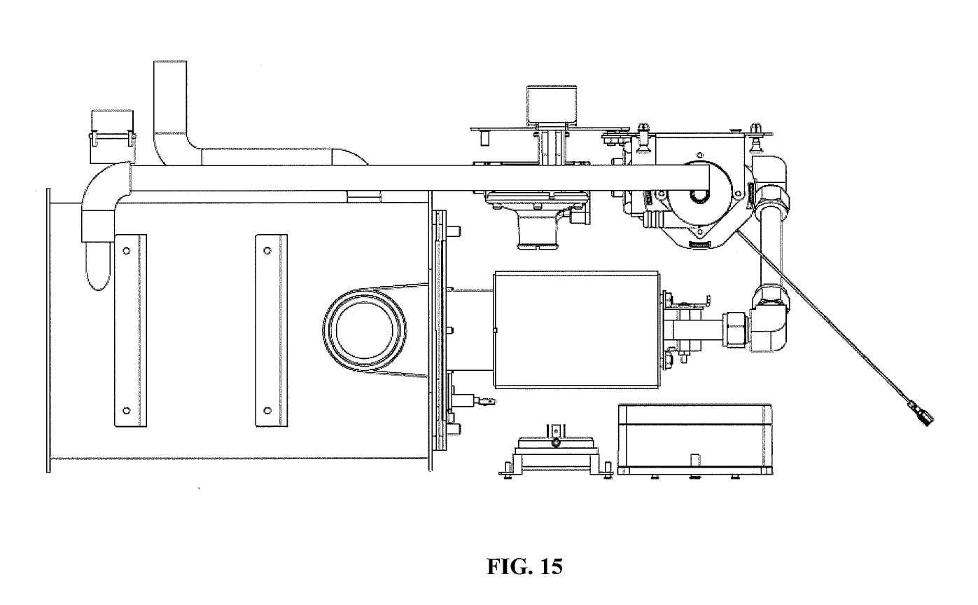

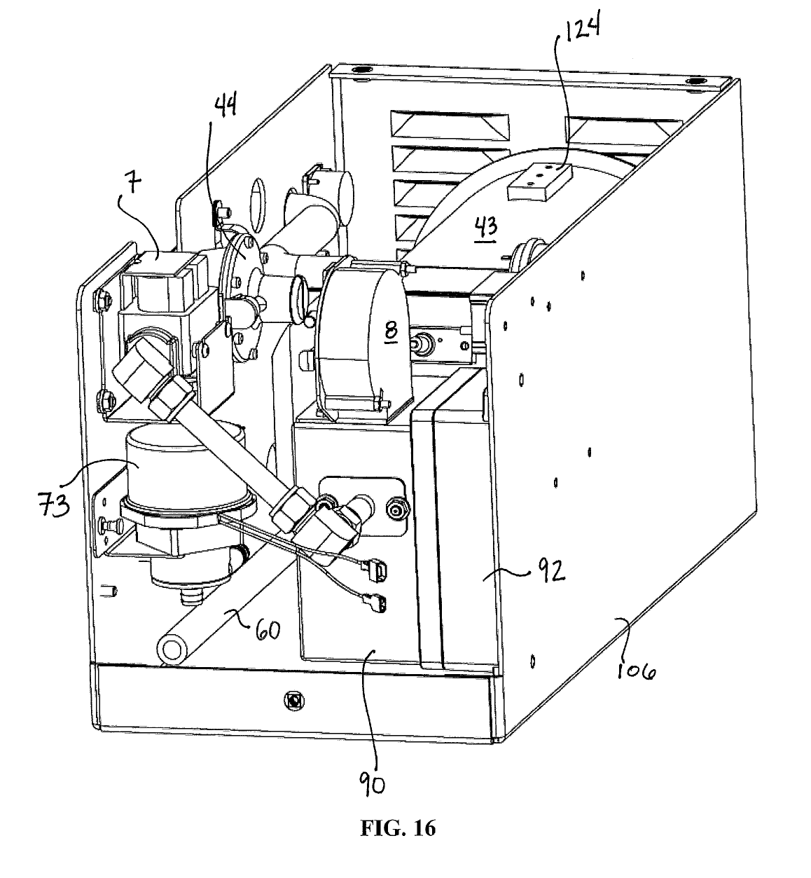

FIG. 15 is a bottom plan view of the heater 82. FIG. 16 is a front right perspective view of the heater 82 with an enclosure 106. The enclosure 106 may include insulation, panels, or covers (e.g., an access cover) (not shown).

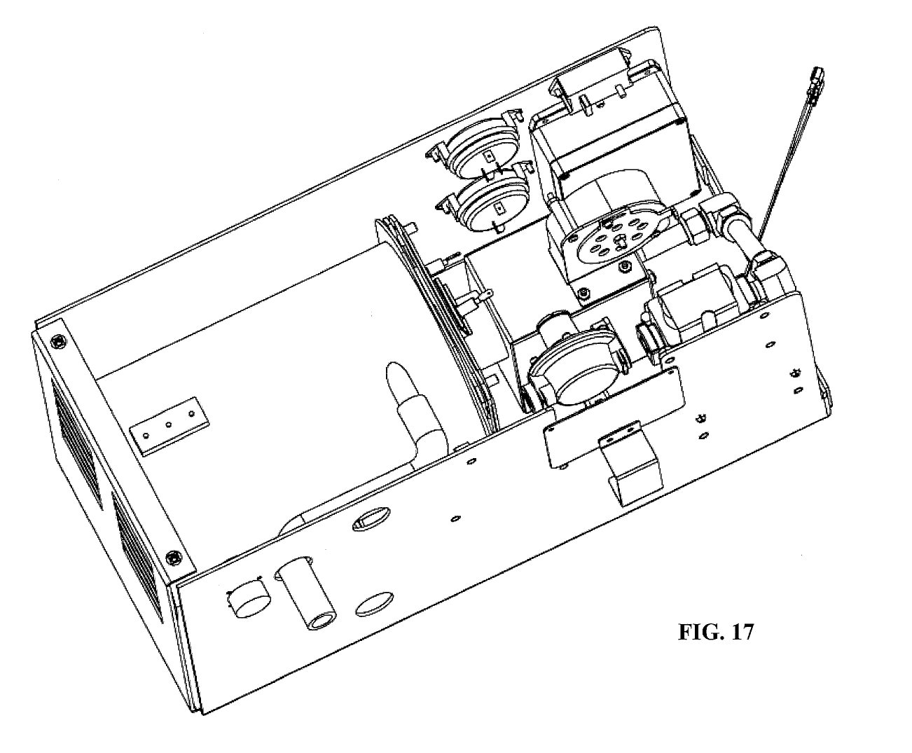

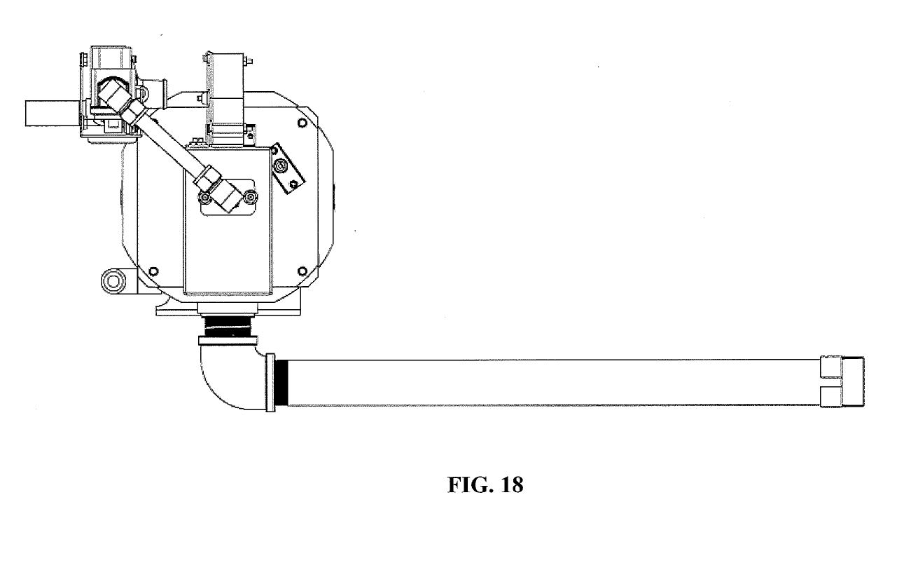

FIG. 17 is a rear left perspective view of the heater 82. FIG. 18 is a front elevation view of a fifth embodiment of a heater 82 with an exhaust pipe interconnected to the exhaust 1. Thus, the combustion products from the combustion chamber can be exhausted through an exhaust pipe. In one embodiment, a portion of the exhaust pipe passes through the coolant or through a heat exchanger in order to extract waste heat from the exhaust.

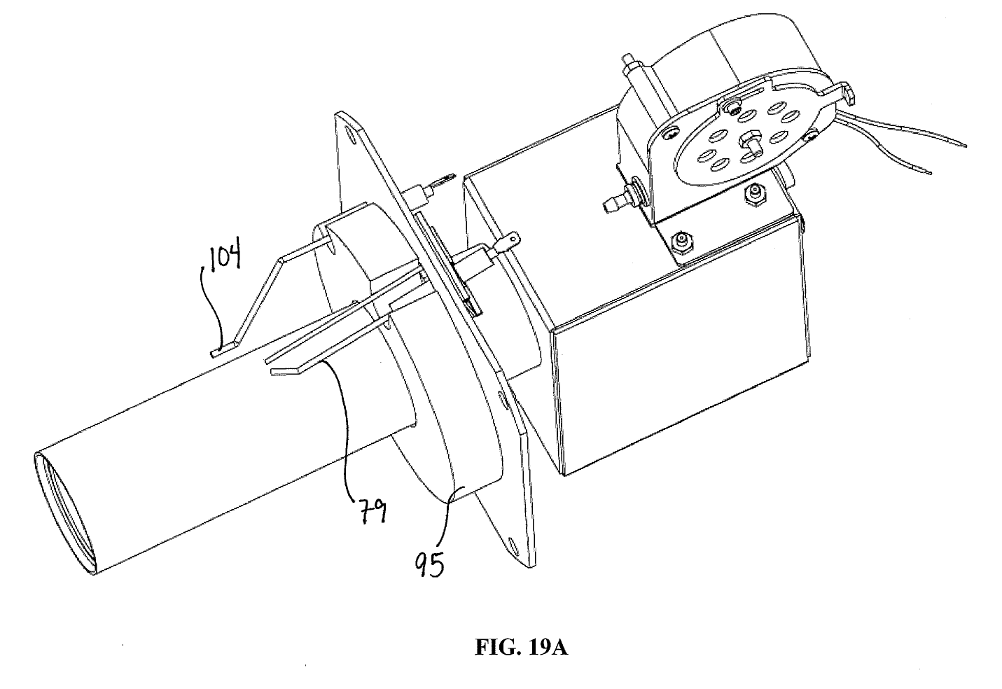

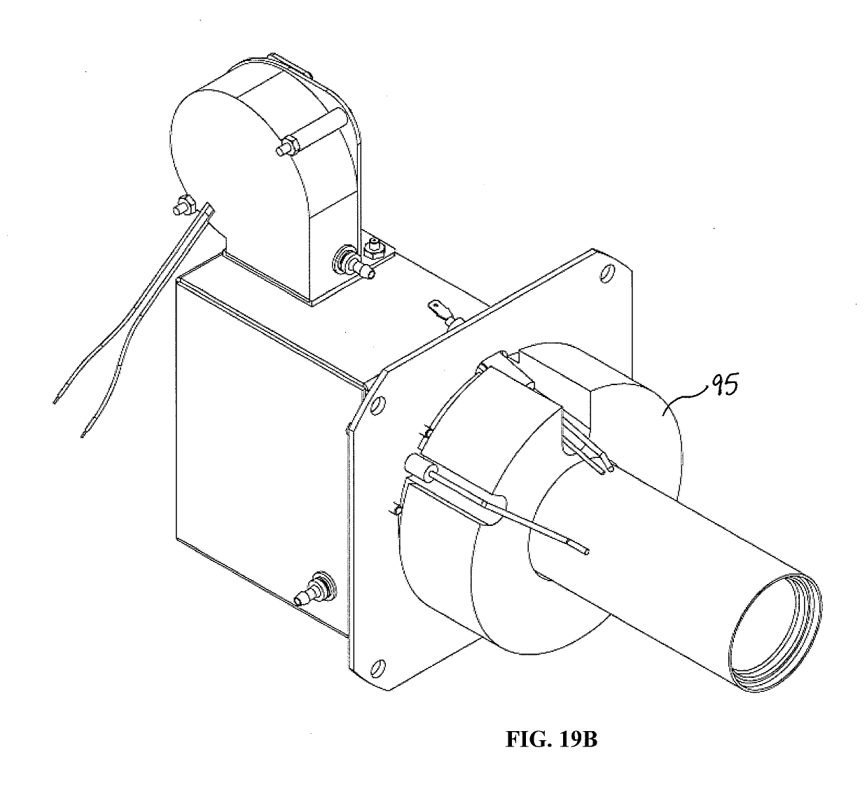

FIG. 19A is a perspective view of one embodiment of the burner components of a heater and FIG. 19B is a perspective view of a second embodiment the burner components of a heater. The burner may include an igniter 79 and a flame sensor 104. FIG. 19B is similar to FIG. 7D in that it has a larger or wider refractory 95 than the embodiment of FIGS. 19A and 7B.

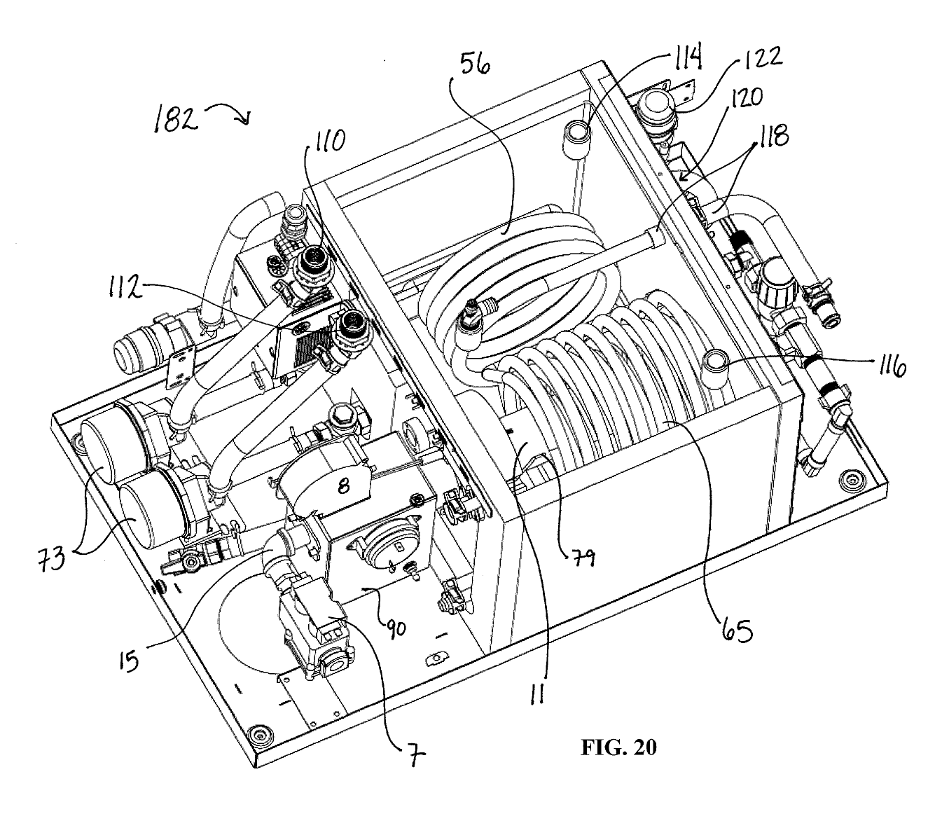

FIG. 20 is a top perspective view of one embodiment of a multi-circuit supplemental heating system. Specifically, the embodiment shown is a triple-circuit supplemental heater 182 comprising circulation pumps 73, a blower 8, a plenum 90, a fuel valve and pressure regulator 7, a fuel entry 15, a spark igniter 79, and coils 65 (which may be copper) encircling the combustion area, flame, and flame tube 11. The heat transfer coil 65 provides thermal energy to preheat a vehicle engine in one mode of operation and provides a source of heat to other heat loads (e.g., a hydraulic reservoir, an oil pan, a fuel pressure regulator, a compartment heater or heat exchanger, a cargo box, a water tank, etc.) when needed and/or when the engine does not need to be preheated. The tank or case may be surrounded by various insulation panels and covers (e.g., an access cover). When assembled, a fluid-tight system is provided for the coolant. The heater 182 comprises a first heat zone inlet 114, a second heat zone inlet 116, and an engine preheat inlet 116. The heater 182 further comprises a first heat zone outlet 110 where heated fluid exits the heater 182 to heat a first zone in the engine heating/cooling system, a second heat zone outlet 112 where heated fluid exits the heater 182 to heat a second zone in the engine heating/cooling system, and an engine preheat outlet 120. The engine preheat circuit has an engine preheat circulation pump 122.

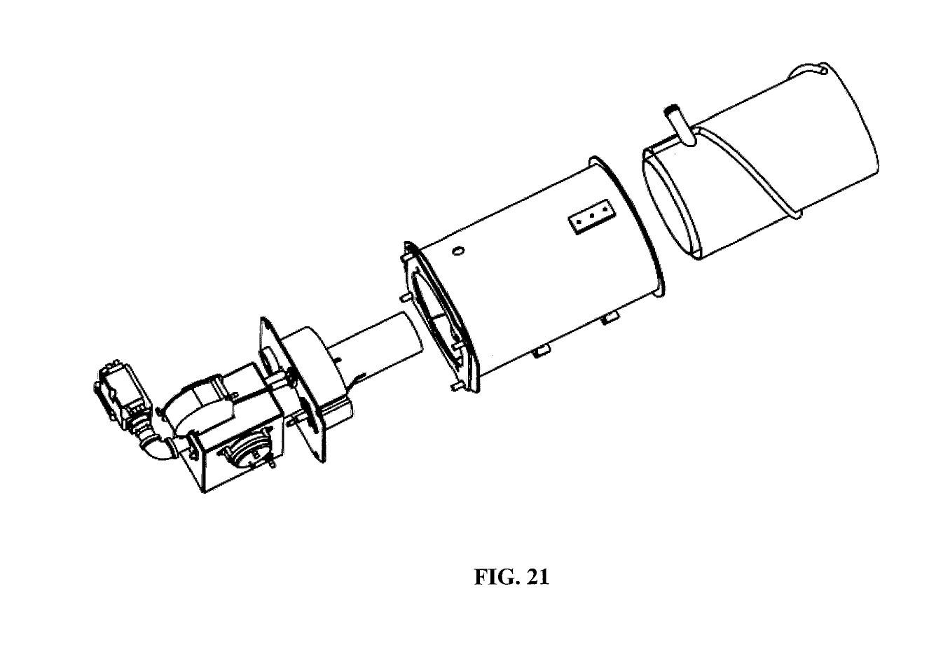

FIG. 21 is an exploded perspective view of an embodiment of a single-circuit supplemental heater 82. The components shown and/or numbered in FIG. 21 correlate to the components shown and/or numbered in previous figures showing single-circuit heaters.

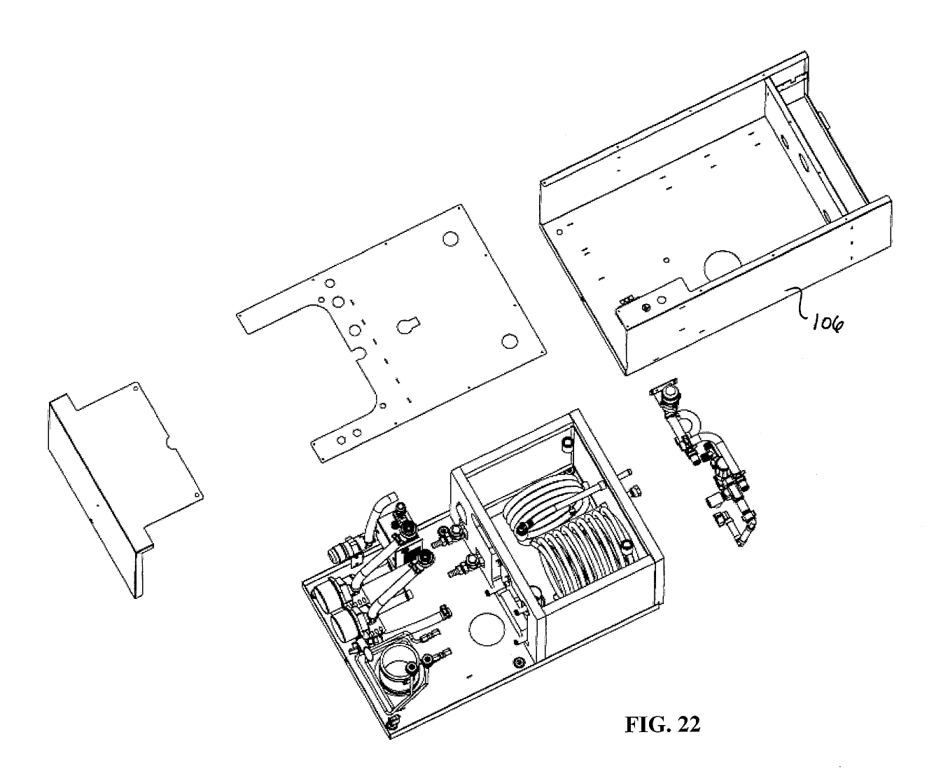

FIG. 22 is an exploded perspective view of an embodiment of a triple-circuit supplemental heater 182 with an enclosure 106. The components shown and/or numbered in FIG. 22 correlate to the components shown and/or numbered in FIG. 20 showing a triple-circuit heater 182.

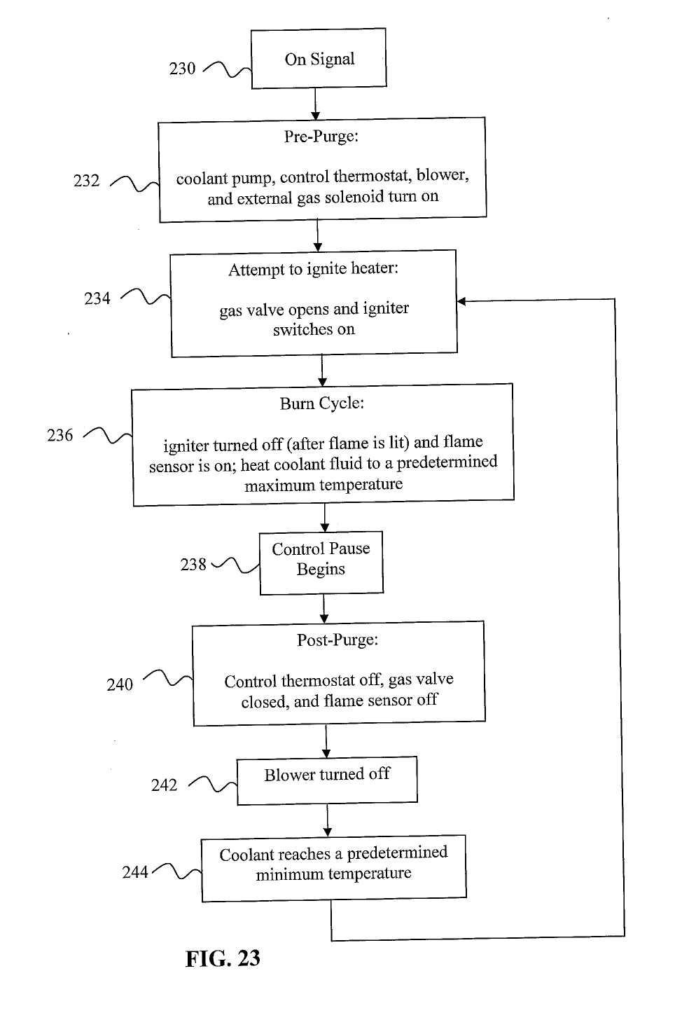

FIG. 23 is a flow chart of the operation of a supplemental heater according to one embodiment. In step 230, an on signal may be provided by a user and received by the heater controls. In a pre-purge step 232, the coolant pump, control thermostat, blower, and external gas solenoid are turned on. The heater attempts to ignite in step 234. Thus, the gas valve opens and the igniter switches on. Once the heater is lit, the burn cycle 236 begins. During the burn cycle step 236, the igniter turns off once the flame is lit, the flame sensor is on, and coolant is heated to a predetermined maximum temperature. Once the coolant reaches the predetermined maximum temperature, a control pause begins in step 238. A post-purge step 240 follows where the control thermostat is turned off, the gas valve is closed, and the flame sensor is off. Once the post-purge step 240 is complete, the blower is turned off in step 242. With the heater turned off, the coolant reaches a predetermined minimum temperature in step 244. The temperature of the coolant may be measured anywhere in the system. In preferred embodiments, the temperature of the coolant is measured somewhere on or in the water jacket or copper coils. After the temperature reaches a predetermined minimum temperature and if heat is still required, the cycle repeats itself starting at step 234.

FIG. 24 is a chart showing the cycling of a supplemental heater according to one embodiment. In this embodiment, the heater system includes a thermostat or heat sensor that is designed to turn on the supplemental heater and/or electric heater when the temperature of the heating medium (e.g., coolant) falls below a predetermined minimum temperature (e.g., 120° F. or 122° F. for the coolant heated by the heater) and to shut off the heater and electric heater when the temperature of the heating medium rises above a predetermined maximum temperature (e.g., 140° F. for the coolant heated by the heater).

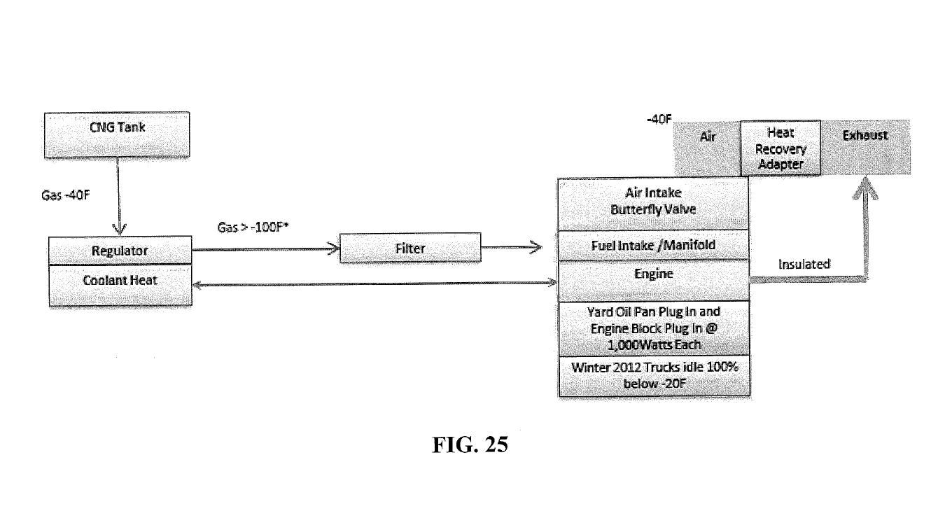

FIG. 25 is a flow chart of a vehicle's coolant system without a supplementary heater. Plug-ins may provide additional heat to some items, e.g., the oil pan and engine block. No supplemental heater is provided in the system of FIG. 25. Therefore, the regulator, fuel intake manifold, and air intake butterfly valve had to wait for the engine to heat up in order to receive heat from the engine coolant.

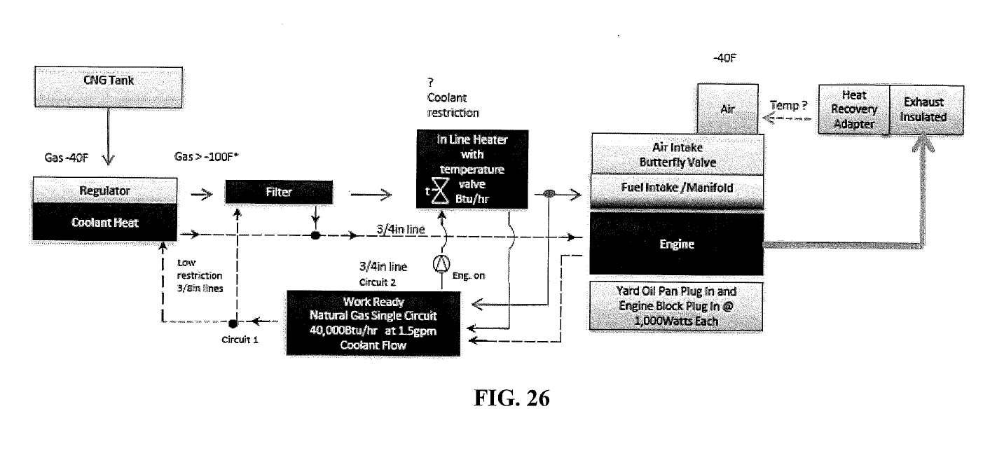

FIG. 26 is a flow chart of a vehicle's coolant system with a supplementary heater. Fuel flows through the system along the path represented by solid, thick lines. Coolant flows through the system along the paths represented by dashed lines (circuit 1) and thin, solid lines (circuit 2). The fuel (e.g., CNG or compressed natural gas) is held within a tank at approximately 3000 psi, or whatever other pressure the vehicle's fuel tank is designed to withstand. The pressure of the fuel is then reduced through a regulator and the temperature of the fuel drops from about −40° F. to about −100° F. as the fuel's pressure drops. Accordingly, heat at the regulator is desired. The fuel then flows through a filter, through an in-line heater, and then to a junction point where the fuel may either go into the fuel intake/manifold on the engine, into the supplemental heater, or to both the engine and the heater where the fuel is burned.

The supplemental heater (e.g., Work Ready heater in FIG. 26) may heat coolant and provide heated coolant to the regulator. When the supplemental heater is in operation, the fuel flow and heat exchangers are warmed. The supplemental heater may also provide heated coolant to heat the filter, either in line with the regulator or in series with the regulator. The heated coolant then flows to the engine to provide heat to the engine if needed in very cold temperatures and/or to avoid a thermo shock to the engine prior to starting. The heater may heat circuit 1 when the engine is either on or off. In some embodiments, the heater may provide heated coolant to the in-line fuel heater through a second circuit in order to heat the fuel before it enters the fuel intake/manifold on the engine and/or heat the fuel before it enters the supplemental heater. This second circuit is only used when the engine is on and it is often not needed in summer months or on warm days. Thus, the second circuit is separate from the first circuit such that the second circuit may be turned off if it is not needed. Circuit 2 is in parallel with circuit 1 as connected to the supplemental heater. Circuit 2 will operate if the ignition signal is present and the in-line heater thermostat is closed. The fuel intake/manifold and air intake valve may also be heated by hot air coming off of the engine.

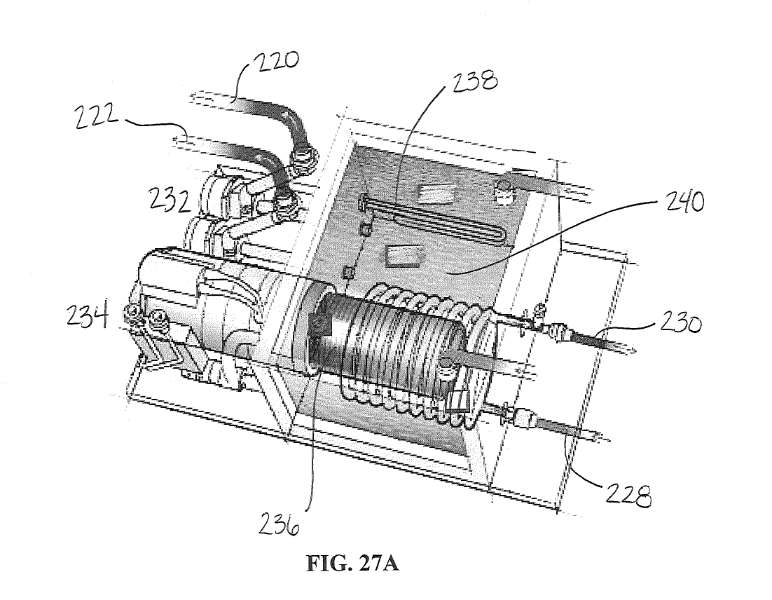

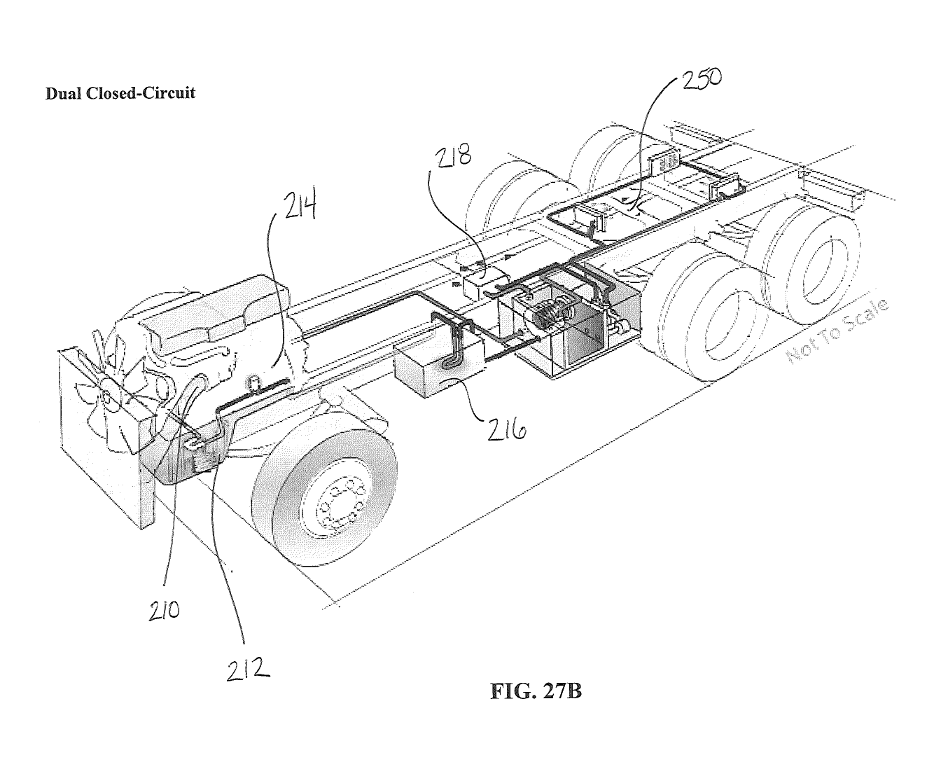

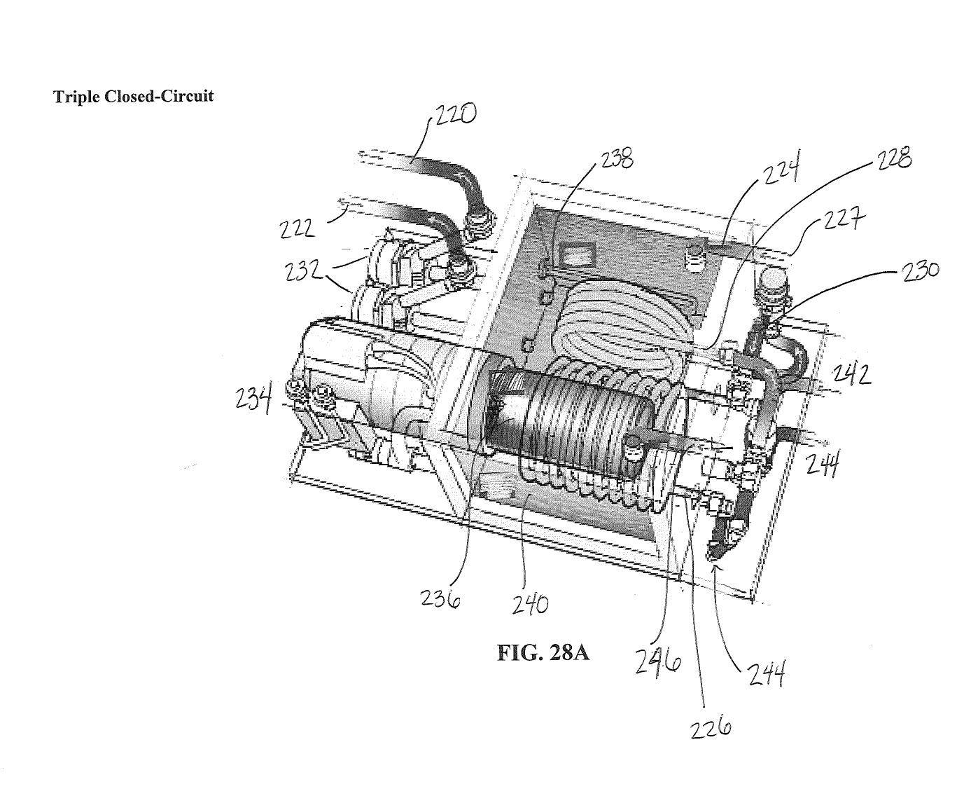

FIG. 27A shows a dual closed-circuit supplemental heater comprising a heat zone 1 outlet 220, a heat zone 2 outlet 222, a heat zone 1 return 224, a heat zone 2 return 226, an engine preheat inlet 228, an engine preheat outlet 230, zone circulation pumps 232, a fuel inlet outlet 234, a burner chamber 236, an electric heating element 238, and a thermal storage tank 240. FIG. 27B shows the dual closed-circuit supplemental heater interconnected to a vehicle engine. The system comprises engine preheating 200, an oil pan 212, a fuel pressure regulator 214, a hydraulics reservoir 216, an operator cabin exchanger 218, and a cargo/work box 250. The heater provides heat to the engine, oil pan 212, fuel pressure regulator 214, hydraulics reservoir 216, operator cabin exchanger 218, and cargo/work box 250.

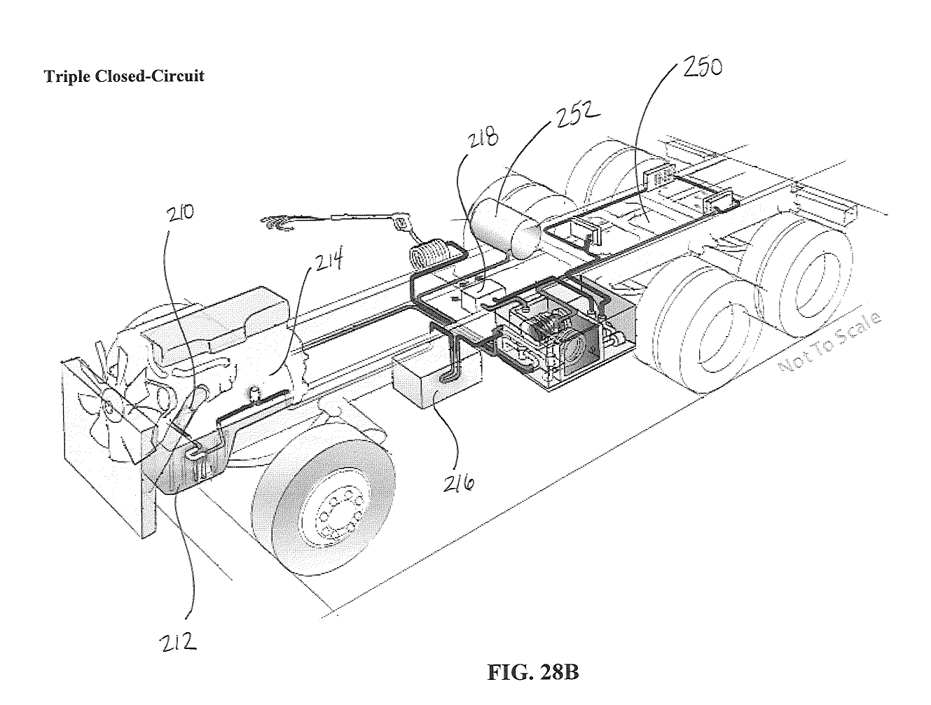

FIG. 28A shows a triple closed-circuit supplemental heater comprising a heat zone 1 outlet 220, a heat zone 2 outlet 222, a heat zone 1 return 224, a heat zone 2 return 226, an engine preheat circulation pump 227, an engine preheat inlet 228, an engine preheat outlet 230, zone circulation pumps 232, a fuel inlet outlet 234, a burner chamber 236, an electric heating element 238, a thermal storage tank 240, a cold water inlet 242, a hot water outlet 244, and a water tempering valve 246. FIG. 28B shows a triple closed-circuit supplemental heater interconnected to a vehicle engine. The system comprises engine preheating 200, an oil pan 212, a fuel pressure regulator 214, a hydraulics reservoir 216, an operator cabin exchanger 218, a cargo/work box 250, and a water/fluid tank 252. The heater provides heat to the engine, oil pan 212, fuel pressure regulator 214, hydraulics reservoir 216, operator cabin exchanger 218, cargo/work box 250, and water/fluid tank 252.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting.

What is claimed is:

1. A motor vehicle with a heating system, the motor vehicle comprising:
an engine comprising a first port through which a fluid exits the engine and a second port through which the fluid enter the engine, wherein the engine employs a source of fuel selected from the group consisting of propane and natural gas;
a compartment heater having an inlet port through which the fluid enters, an outlet port through which the fluid exits, and a heat exchanger;
an auxiliary coolant heater comprising:
an inlet port through which the fluid enters the auxiliary coolant heater;
an outlet port through which heated fluid exits the auxiliary coolant heater;
a blower;
a combustion chamber comprising an igniter and a burner tube;
a plenum;
a heat transfer medium;
an exhaust port; and
wherein the engine and the auxiliary coolant heater employ the same fuel source; and
a coolant flow system comprising:
a first flow path that interconnects the compartment heater inlet port, the compartment heater outlet port, the auxiliary coolant heater inlet port, and the auxiliary coolant heater outlet port, wherein the first flow path provides for the fluid to flow from the auxiliary coolant heater outlet port through the compartment heater and back to the auxiliary coolant heater inlet port;
a second flow path that interconnects the engine first port, the engine second port, the auxiliary coolant heater inlet port, and the auxiliary coolant heater outlet port, wherein the second flow path provides for heated fluid to flow from the auxiliary coolant heater outlet port to the engine second port to heat the engine;
a fluid pump in fluid communication with at least one of the first flow path and the second flow path;
a valve assembly having a first state and a second state, wherein the valve assembly is in fluid communication with the first flow path and the second flow path; and
a control system interconnected to the valve assembly, wherein the control system moves the valve assembly between the first state and the second state.

2. The motor vehicle of claim 1, wherein when the valve assembly is in the first state, the fluid flows through the first flow path.

3. The motor vehicle of claim 1, wherein the engine is a liquid-cooled combustion engine.

4. The motor vehicle of claim 1, wherein the fluid is a mixture of water and coolant.

5. The motor vehicle of claim 1, wherein the heat transfer medium is a tank that encases at least a portion of the fluid around the combustion chamber.

6. The motor vehicle of claim 1, wherein the heat transfer medium is copper tubing through which the fluid flows, and wherein the copper tubing is positioned proximate to the combustion chamber.

7. The motor vehicle of claim 1, further comprising a water tank for storing water having an inlet and an outlet, wherein the water tank outlet is interconnected to a third flow path which is interconnected to a third inlet port of the auxiliary coolant heater, and wherein heated water exits the auxiliary coolant heater through a third outlet port.

8. The motor vehicle of claim 1, further comprising a temperature gauge interconnected to the compartment heater, wherein when the temperature gauge indicates a predetermined maximum temperature the compartment heater is switched to an off position.

9. The motor vehicle of claim 1, wherein the auxiliary coolant heater has a heat output between about 40,000 BTU/hr and about 50,000 BTU/hr, and wherein the auxiliary coolant heater operates on 12 VDC.

10. The motor vehicle of claim 1, where in the auxiliary coolant heater is accessible from the outside of the vehicle.

11. An auxiliary coolant heater system for a vehicle comprising:
an inlet port through which a fluid enters the auxiliary coolant heater system for heating;
an outlet port through which heated fluid exits the auxiliary coolant heater system;
a blower;
a combustion chamber comprising an igniter and a burner tube;
a plenum;
a water jacket;
an exhaust;
a first flow path for the heated fluid that connects the outlet port to an inlet port of at least one of a vehicle engine, a compartment heat exchanger, a hydraulics heat exchanger, a fuel regulator, and an oil pan heat exchanger;
a second flow path for the heated fluid, wherein the second flow path connects the outlet port to an in-line heater, and wherein the in-line heater is interconnected to the vehicle engine; and
a fluid pump in fluid communication with at least one of the first flow path and the second flow path.

12. The auxiliary coolant heater system of claim 11, wherein the water jacket surrounds a heat exchanger tank, wherein the heat exchanger tank surrounds the combustion chamber, and wherein fluid is positioned between the water jacket and the heat exchanger tank such that the fluid is in a heat transfer relationship with the heat exchanger tank and the water jacket.

13. The auxiliary coolant heater system of claim 11, wherein the auxiliary coolant heater system operates on natural gas, and wherein air and natural gas mix within the plenum at a pressure between about 0.35 and 0.45 inch water column before entering the combustion chamber.

14. A method of heating one or more vehicle components comprising:
providing the one or more vehicle components, wherein the vehicle components are selected from the group consisting of an engine, a compartment, a hydraulic system, an oil pan, and a fuel regulator;
providing a compartment heater having an inlet port through which the fluid enters, an outlet port through which the fluid exits, and a heat exchanger;
providing an auxiliary coolant heater system, wherein the auxiliary coolant heater employs a source of fuel selected from the group consisting of propane and natural gas, and wherein the auxiliary coolant heater system comprises:
an inlet port through which the fluid enters the auxiliary coolant heater system for heating;
an outlet port through which heated fluid exits the auxiliary coolant heater system;
a combustion chamber comprising an igniter and a burner tube;
a heat transfer medium; and
an exhaust;
providing one or more flow paths between the auxiliary coolant heater system and at least one of the one or more vehicle components;
providing a fuel source selected from the group comprising propane fuel and natural gas fuel;
burning a mixture of air and the fuel source in the combustion chamber;
transferring heat from the mixture to the heat transfer medium; and
transferring heat from the heat transfer medium to at least one of the one or more vehicle components.

15. The method of heating a vehicle engine of claim 14 further comprising providing a fluid pump.

16. The method of heating a vehicle engine of claim 14 further comprising providing a first flow path that connects a compartment heater inlet port, a compartment heater outlet port, the auxiliary coolant heater inlet port, and the auxiliary coolant heater outlet port such that the first flow path provides for the fluid to flow from the auxiliary coolant heater outlet port through the compartment heater and back to the auxiliary coolant heater inlet port.

17. The method of heating a vehicle engine of claim 16 further comprising providing a second flow path that connects an engine first port, an engine second port, the auxiliary coolant heater inlet port, and the auxiliary coolant heater outlet port such that the second flow path provides for heated fluid to flow from the auxiliary coolant heater outlet port to the engine second port to heat the engine.

18. The method of heating a vehicle engine of claim 14, wherein the auxiliary coolant heater uses natural gas, and wherein a fuel content volume is about 56 cubic feet and the fuel content quality is between about 900 and 1,100 BTU cubic feet.

19. The method of heating a vehicle engine of claim 14, wherein the auxiliary coolant heater uses propane, and wherein a fuel content volume is about 22 cubic feet and the fuel content quality is about 2,516 BTU cubic feet.

20. The method of heating a vehicle engine of claim 14, wherein the auxiliary coolant heater uses natural gas, and wherein air and fuel mix within a plenum at a pressure between about 0.35 and 0.45 inch water column and a pressure within the combustion chamber is between approximately 0.2 and 0.2 inch water column, which creates a back pressure at an entrance of the combustion chamber.
